(19) United States
(12) Patent Application Publication
(10) Pub. No.: US 2025/0271866 A1
(43) Pub. Date: Aug. 28, 2025

(54) HUMAN-POWERED VEHICLE CONTROL DEVICE, METHOD OF CONTROLLING HUMAN-POWERED VEHICLE, AND COMPUTER PROGRAM

(71) Applicant: Shimano Inc., Osaka (JP)

(72) Inventors: Kenji TAGAWA, Osaka (JP); Ryota YAMAGUCHI, Osaka (JP)

(21) Appl. No.: 19/038,236

(22) Filed: Jan. 27, 2025

(30) Foreign Application Priority Data
Feb. 27, 2024 (JP) 2024-027840

(51) Int. Cl. G05D 1/644; B62J 50/21; B62J 50/22; G05D 101/15; G05D 109/10

(52) U.S. Cl. CPC G05D 1/644; B62J 50/22; B62J 50/225; G05D 2101/15; G05D 2109/13

(57) ABSTRACT

A human-powered vehicle control device includes a processor configured to read information from a memory and execute processing. The processor is further configured to execute processing of acquiring input information related to traveling of a human-powered vehicle, performing automatic control on a controlled device provided to the human-powered vehicle by control data of the controlled device, the control data being decided based on the input information acquired, changing, based on the input information, a parameter related to automatic control of the controlled device through learning an intervening operation performed on the automatic control by a rider, and resetting the parameter related to the automatic control, which is changed through learning, to predetermined data in a case where a predetermined condition is satisfied.

### CROSS-REFERENCE TO RELATED APPLICATIONS

This application claims priority to Japanese Patent Application No. 2024-027840, filed on Feb. 27, 2024. The entire disclosure of Japanese Patent Application No. 2024-027840 is hereby incorporated herein by reference.

### BACKGROUND

### Technical Field

The present disclosure generally relates to a human-powered vehicle control device, a method of controlling a human-powered vehicle, and a computer program.

### Background Information

A human-powered vehicle is increasingly equipped with an electric component, and automatic control of a mounted device including a transmission, a braking device, and an assist device is achieved. Information related to the automatic control of the mounted device is individually learned and optimized in order to match a physical feature of a rider, a preference of the rider, and the like (See, e.g., Japanese Patent No. 6,985,217 B and the like).

### SUMMARY

In a case where optimization of the automatic control proceeds in a direction not intended by the rider, it is desirable that the automatic control can be reset, and learning can be performed again. Since ride sharing is becoming popular, it is preferable that the optimization of automatic control can be reset in a case where the rider changes.

An object of the present disclosure is to provide a human-powered vehicle control device, a method of controlling a human-powered vehicle, and a computer program capable of resetting a setting of automatic control that performs optimization for each rider.

A human-powered vehicle control device according to a first aspect of the present disclosure includes a processor configured to read information from a memory and that execute processing. The processor is further configured to execute processing of acquiring input information related to traveling of a human-powered vehicle, performing automatic control on a controlled device provided to the human-powered vehicle by control data of the controlled device, the control data being decided based on the input information acquired, changing, based on the input information, a parameter related to automatic control of the controlled device through learning an intervening operation performed on the automatic control by a rider, and resetting the parameter related to the automatic control, which is changed through learning, to predetermined data in a case where a predetermined condition is satisfied.

According to the human-powered vehicle control device of the first aspect, the setting of the automatic control changed through learning the intervening operation performed on the automatic control of the human-powered vehicle by the rider can be reset based on the predetermined condition.

In the human-powered vehicle control device of a second aspect of the present disclosure according to the first aspect, the processor is further configured to execute processing of deciding the control data in accordance with a predetermined control algorithm based on the input information, and resetting a parameter of the predetermined control algorithm as the parameter related to the automatic control to the predetermined data in a case where the predetermined condition is satisfied.

According to the human-powered vehicle control device according to the second aspect, the setting of the automatic control of the human-powered vehicle in accordance with the predetermined control algorithm can be reset based on the predetermined condition.

In the human-powered vehicle control device of a third aspect of the present disclosure according to the first or second aspect, the processor is further configured to execute processing of deciding the control data in accordance with a predetermined control algorithm based on the input information, changing the parameter of the predetermined control algorithm in a case where a probability of a rider performing the intervening operation on the automatic control of the controlled device is determined to be equal to or more than a predetermined value using an operation probability output model that outputs a probability of a rider performing an intervening operation on the automatic control of the controlled device, and resetting at least one of parameters of the operation probability output model and the parameter of the predetermined control algorithm to the predetermined data in a case where the predetermined condition is satisfied.

According to the human-powered vehicle control device of the third aspect, in changing the setting of the automatic control of the human-powered vehicle by using the learning model for predicting the probability of the rider performing the intervening operation, the change of the setting can be reset in a case where the predetermined condition is satisfied.

In the human-powered vehicle control device of a fourth aspect of the present disclosure according to the third aspect, the processor is further configured to change the parameter of the predetermined control algorithm in a case where the probability output from the operation probability output model is equal to or more than the predetermined value, and the intervening operation having been performed is confirmed.

According to the human-powered vehicle control device of the fourth aspect, in changing the setting of the automatic control of the human-powered vehicle by using the learning model for predicting the probability of the rider performing the intervening operation, the setting is changed in the case where the intervening operation having been performed is confirmed. This makes it possible to avoid the automatic control that does not meet the rider's intention.

In the human-powered vehicle control device of a fifth aspect of the present disclosure according to the first or second aspect, the processor is further configured to use a specific operation performed to an operation device of the human-powered vehicle as the predetermined condition and resets the parameter in a case where the specific operation is performed.

According to the human-powered vehicle control device of the fifth aspect, the setting of the automatic control changed through learning the intervening operation performed on the automatic control of the human-powered vehicle by the rider can be reset based on the condition that the specific operation has been performed on the operation device.

In the human-powered vehicle control device of a sixth aspect of the present disclosure according to the first or second aspect, the input information includes a travel speed of the human-powered vehicle, the parameter is set for each different section of the travel speed, and the processor is further configured to execute resetting in a case where, under the predetermined condition in which not only a parameter of a section including the travel speed of the input information but also a parameter of another section is changed, it is determined that the parameter of another section is changed.

According to the human-powered vehicle control device according to the sixth aspect, the setting of the automatic control changed according to the travel speed through learning the intervening operation performed on the automatic control of the human-powered vehicle by the rider can be reset. The setting of the automatic control can be reset based on the condition that it is determined that the travel speed reaches another travel section different from the travel speed during traveling.

In the human-powered vehicle control device of a seventh aspect of the present disclosure according to any one of the first to sixth aspects, the processor is further configured to report resetting to a rider in a case where the processor executes a reset.

According to the human-powered vehicle control device of the seventh aspect, the setting of the automatic control of the human-powered vehicle can be reset, and in addition, the rider can be made aware that the setting has been reset.

In the human-powered vehicle control device of an eighth aspect of the present disclosure according to the seventh aspect, the resetting is reported to the rider by at least one of text, color or brightness displayed on a display unit.

According to the human-powered vehicle control device of the eighth aspect, the setting of the automatic control of the human-powered vehicle can be reset, and in addition, the rider can visually recognize that the setting has been reset.

In the human-powered vehicle control device of a ninth aspect of the present disclosure according to the eighth aspect, the display unit is a display configured to be disposed at a handlebar of the human-powered vehicle.

According to the human-powered vehicle control device of the ninth aspect, in addition to being able to reset the setting of the automatic control of the human-powered vehicle, the rider can be caused to recognize that the setting has been reset, with the display that is easily visible.

In the human-powered vehicle control device of a tenth aspect of the present disclosure according to the eighth aspect, the display unit is a part of an information terminal device of a rider of the human-powered vehicle.

According to the human-powered vehicle control device of the tenth aspect, the setting of the automatic control of the human-powered vehicle can be reset, and in addition, the resetting can be recognized through the information terminal device that is usually used by the rider.

In the human-powered vehicle control device of an eleventh aspect of the present disclosure according to any one of the first to tenth aspects, the controlled device is a transmission device of the human-powered vehicle, and the input information includes a cadence of a crank in a driving mechanism of the human-powered vehicle, and the processor is further configured to raise or lower a reference cadence as the parameter, the reference cadence being compared to the cadence for determining a gear ratio in the transmission device.

According to the human-powered vehicle control device of the eleventh aspect, the parameter related to the setting of the automatic control to be optimized for the rider is the reference cadence for determining the gear ratio of the transmission device, and the change of the reference cadence can be reset.

In the human-powered vehicle control device of a twelfth aspect of the present disclosure according to the eleventh aspect, the input information includes a travel speed of the human-powered vehicle, the reference cadence is set for each different section of the travel speed, and the processor is further configured to change the reference cadence in a section including the travel speed of the input information while maintaining a difference from a reference cadence in an adjacent section within a predetermined range.

According to the human-powered vehicle control device of the twelfth aspect, the parameter related to the setting of the automatic control to be optimized for the rider is the reference cadence for determining the gear ratio of the transmission device, the reference cadence is set to vary depending on the travel speed of the human-powered vehicle, and the change of the reference cadence can be reset.

In the human-powered vehicle control device of a thirteenth aspect of the present disclosure according to any one of the first to twelfth aspects, the controlled device is a transmission device of the human-powered vehicle, and the input information includes a torque of a crank in a driving mechanism of the human-powered vehicle, and the processor is further configured to raise or lower a reference torque as the parameter, the reference torque being compared to the torque for determining a gear ratio in the transmission device.

According to the human-powered vehicle control device of the thirteenth aspect, the parameter related to the setting of the automatic control to be optimized for the rider is the reference torque for determining the gear ratio of the transmission device, and the change of the reference torque can be reset.

In the human-powered vehicle control device of a fourteenth aspect of the present disclosure according to any one of the first to thirteenth aspects, the controlled device is an assist device of the human-powered vehicle, and the input information includes a cadence of a crank in a driving mechanism of the human-powered vehicle, and the processor is further configured to raise or lower a reference cadence as the parameter, the reference cadence being compared to the cadence for determining an output of the assist device.

According to the human-powered vehicle control device of the fourteenth aspect, the parameter related to the setting of the automatic control to be optimized for the rider is the reference cadence for determining the output of the assist device, and the change of the reference cadence can be reset.

In the human-powered vehicle control device of a fifteenth aspect of the present disclosure according to the fourteenth aspect, the input information includes a travel speed of the human-powered vehicle, the reference cadence is set for each different section of the travel speed, and the processor is further configured to change the reference cadence in a section including the travel speed of the input information while maintaining a difference from a reference cadence in an adjacent section within a predetermined range.

According to the human-powered vehicle control device of the fifteenth aspect, the parameter related to the setting of the automatic control to be optimized for the rider is the reference cadence for determining the output of the assist device, the reference cadence is set to vary depending on the travel speed of the human-powered vehicle, and the change of the reference cadence can be reset.

In the human-powered vehicle control device of a sixteenth aspect of the present disclosure according to any one of the first to fifteenth aspects, the controlled device is an assist device of the human-powered vehicle, and the input information includes a torque of a crank in a driving mechanism of the human-powered vehicle, and the processor is further configured to raise or lower a reference torque as the parameter, the reference torque being compared to the torque included for determining an output of the assist device.

According to the human-powered vehicle control device of the sixteenth aspect, the parameter related to the setting of the automatic control to be optimized for the rider is the reference torque for determining the output of the assist device, and the change of the reference torque can be reset.

A human-powered vehicle control method according to a seventeenth aspect of the present disclosure is executed by a computer, the human-powered vehicle control method comprises acquiring input information related to traveling of a human-powered vehicle, deciding control data of a controlled device provided to the human-powered vehicle based on the input information acquired, changing, based on the input information, a parameter related to automatic control of the controlled device through learning an intervening operation performed on the automatic control by a rider, and resetting the parameter related to the automatic control, which is changed through learning, to predetermined data in a case where a predetermined condition is satisfied.

According to the method of controlling the human-powered vehicle of the seventeenth aspect, the setting of the automatic control changed through learning the intervening operation performed on the automatic control of the human-powered vehicle by the rider can be reset based on the predetermined condition.

A computer program according to an eighteenth aspect of the present disclosure is disposed upon a non-transitory computer readable storage medium and executable by a computer. The computer program is configured to cause the computer to execute processing of acquiring input information related to traveling of a human-powered vehicle, deciding control data of a controlled device provided to the human-powered vehicle based on the input information acquired, changing, based on the input information, a parameter related to automatic control of the controlled device through learning an intervening operation performed on the automatic control by a rider, and resetting the parameter related to the automatic control, which is changed through learning, to predetermined data in a case where a predetermined condition is satisfied.

According to the computer program of the eighteenth aspect, the setting of the automatic control changed through learning the intervening operation performed on the automatic control of the human-powered vehicle by the rider can be reset based on the predetermined condition.

According to the human-powered vehicle control device, the method of controlling the human-powered vehicle, and the computer program of the present disclosure, in a case where optimization in progress in the human-powered vehicle control device progresses in a direction different from the rider's intention, resetting can be performed. The human-powered vehicle control device provided to the human-powered vehicle of the ride sharing can reset the setting for each of riders, and can learn according to individual preferences.

### BRIEF DESCRIPTION OF THE DRAWINGS

Referring now to the attached drawings which form a part of this original disclosure, an illustrative embodiment is shown.

FIG. 1 is a side elevational view of a human-powered vehicle to which a human-powered vehicle control device is applied according to a first embodiment.

FIG. 2 is a block diagram illustrating a configuration of the human-powered vehicle control device.

FIG. 3 is a schematic diagram of a control algorithm of a transmission device executed by a processor of a device control unit.

FIG. 4 is a flowchart illustrating an example of a change procedure of a control parameter executed by the processor.

FIG. 5 is a flowchart illustrating an example of a reset processing procedure of the control parameter executed by the processor.

FIG. 6 is a diagram schematically illustrating a human-powered vehicle control system.

FIG. 7 is a block diagram illustrating a configuration of a human-powered vehicle control device in accordance with a second embodiment.

FIG. 8 is a block diagram illustrating a configuration of an information terminal device.

FIG. 9 is a flowchart illustrating an example of a change procedure of a control parameter executed by the processor in the second embodiment.

FIG. 10 is a flowchart illustrating an example of a reset processing procedure of the control parameter executed by the processor in the second embodiment.

FIG. 11 is a diagram illustrating a display example on a display unit of the information terminal device.

FIG. 12 is a block diagram illustrating a configuration of a human-powered vehicle control device in accordance with a third embodiment.

FIG. 13 is a schematic diagram of an operation probability output model.

FIG. 14 is a schematic diagram illustrating another learning method of the operation probability output model.

FIG. 15 is a flowchart illustrating an example of a change procedure of a control parameter executed by the processor in the third embodiment.

FIG. 16 is a flowchart illustrating another example of the change procedure of the control parameter executed by the processor in the third embodiment.

FIG. 17 is a flowchart illustrating an example of the reset processing procedure of the control parameter in the third embodiment.

FIG. 18 is a diagram illustrating setting of a reference cadence in accordance with a fourth embodiment.

FIG. 19 is a flowchart illustrating an example of a change processing procedure of the reference cadence executed by the processor in the fourth embodiment.

FIG. 20 is a flowchart illustrating an example of the change processing procedure of the reference cadence executed by the processor in the fourth embodiment.

FIG. 21 is a diagram illustrating a setting of the changed reference cadence.

FIG. 22 is a schematic diagram of a control algorithm of a transmission device in accordance with a fifth embodiment.

FIG. 23 is a flowchart illustrating an example of a change processing procedure of a control parameter executed by the processor in the fifth embodiment.

FIG. 24 is a schematic diagram of a control algorithm of an assist device in accordance with a sixth embodiment.

FIG. 25 is a flowchart illustrating an example of a change processing procedure of a control parameter executed by the processor in the sixth embodiment.

FIG. 26 is a diagram illustrating a setting of a reference cadence in accordance with a seventh embodiment.

FIG. 27 is a schematic diagram of a control algorithm of an assist device in accordance with an eighth embodiment.

FIG. 28 is a flowchart illustrating an example of a change procedure of a control parameter executed by the processor in the eighth embodiment.

### DETAILED DESCRIPTION OF EMBODIMENTS

The following description of embodiments is an example form that can be taken by a human-powered vehicle control device, a method of controlling a human-powered vehicle, and a computer program according to the present disclosure, and is not intended to be limited to the form. The human-powered vehicle control device, the method of controlling the human-powered vehicle, and the computer program according to the present disclosure can take forms different from the respective embodiments, such as modified examples of the respective embodiments and a form obtained by combining at least two modified examples that do not conflict with each other.

In the following description of the embodiments, terms indicating directions such as front, rear, frontward, rearward, left, right, lateral, upward, and downward are used with reference to directions in a state where a rider is seated on a saddle of a human-powered vehicle.

In the following embodiments, a human-powered vehicle control device according to the present disclosure will be referred to as a control device.

### First Embodiment

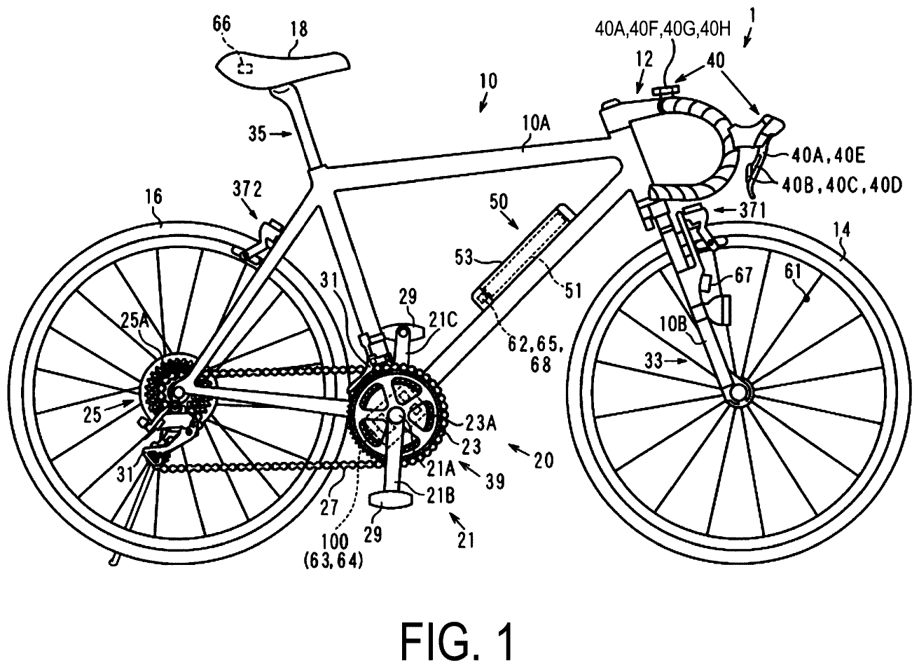

FIG. 1 is a side elevational view of a human-powered vehicle 1 to which a human-powered vehicle control device 100 is applied according to a first embodiment. The human-powered vehicle control device 100 will hereinafter be simply referred to as the control device 100. The human-powered vehicle 1 is a vehicle that uses human power at least partially as a motive power for traveling. A vehicle that uses only an internal combustion engine or an electric motor as a motive power is excluded from the human-powered vehicle 1 of the present embodiment. The human-powered vehicle 1 is, for example, a bicycle such as a mountain bike, a road bike, a cross bike, a city cycle, or an electric assist bike (e-bike).

The human-powered vehicle 1 includes a vehicle body 10, a handlebar 12, a front wheel 14, a rear wheel 16, and a saddle 18. The human-powered vehicle 1 includes a driving mechanism 20, a controlled device 30, an operation apparatus 40, a battery 50, and a sensor 60. The controlled device 30 can also be referred to as a selected device 30, or a targeted device 30.

The vehicle body 10 includes a frame 10A and a front fork 10B. The front wheel 14 is supported rotatably in a pitch direction to a tip end of the front fork 10B. The rear wheel 16 is supported rotatably to the frame 10A. The handlebar 12 is supported rotatably in a yaw direction to the frame 10A. A tip end portion of the handlebar 12 is mounted on a base end of the front fork 10B. This allows the handlebar 12 to change a travel direction of the front wheel 14.

The driving mechanism 20 includes a crank 21, a first sprocket assembly 23, a second sprocket assembly 25, a chain 27, and a pair of pedals 29.

The crank 21 includes a crankshaft 21A, a right crank 21B, and a left crank 21C. The crankshaft 21A is supported rotatably in the pitch direction to the frame 10A. Each of the right crank 21B and the left crank 21C is coupled to the crankshaft 21A. One of the pair of pedals 29 is supported rotatably in the pitch direction to the right crank 21B. The other of the pair of pedals 29 is supported rotatably in the pitch direction to the left crank 21C.

The first sprocket assembly 23 is integrally and rotatably coupled to the crankshaft 21A. The first sprocket assembly 23 includes one or a plurality of sprockets 23A. In one example, the first sprocket assembly 23 includes a plurality of the sprockets 23A having different outer diameters.

The second sprocket assembly 25 is supported rotatably to a rear hub of the rear wheel 16. The second sprocket assembly 25 includes one or a plurality of sprockets 25A. In one example, the second sprocket assembly 25 includes a plurality of the sprockets 25A having different outer diameters.

The chain 27 is wound around any sprocket 23A of the first sprocket assembly 23 and any sprocket 25A of the second sprocket assembly 25. In a case where the crank 21 rotates forward by human-powered driving forces applied to the pedals 29, the sprocket 23A rotates forward together with the crank 21, and the rotation of the sprocket 23A is transmitted to the sprocket 25A of the second sprocket assembly 25 via the chain 27. Rotation of the sprocket 25A causes the rear wheel 16 to rotate. Instead of the chain 27, a belt or a shaft can be used.

In one example, the control device 100 is mounted on the battery 50, a cycle computer, a drive unit, or the like of the human-powered vehicle 1. The control device 100 is connected to the controlled device 30, the operation apparatus 40, and the battery 50. Details of the connection form and the control device 100 will be described below.

The human-powered vehicle 1 includes the controlled device 30 that is operated by electric power supplied from the battery 50 and the operation thereof is controlled by the control device 100. The controlled device 30 includes a transmission device 31, a suspension 33, a seat post 35, a braking device 37, and an assist device 39. The controlled device 30 basically operates under the control of the control device 100 in accordance with an operation on the operation apparatus 40. A control target of the control device 100 is at least one of the controlled device 30, the transmission device 31, the suspension 33, the seat post 35, the braking device 37, and the assist device 39.

The transmission device 31 changes a ratio of a rotational speed of the rear wheel 16 to a rotational speed of the crank 21, that is, the gear ratio of the human-powered vehicle 1. The gear ratio is represented by a ratio of an output rotational speed output from the transmission device 31 to an input rotational speed input to the transmission device 31. The gear ratio is expressed by an equation of “gear ratio=output rotational speed/input rotational speed”. In a first example, the transmission device 31 is an external transmission (rear derailleur) that changes the coupling state between the second sprocket assembly 25 and the chain 27. In a second example, the transmission device 31 is an external transmission (front derailleur) that changes the coupling state between the first sprocket assembly 23 and the chain 27. In a third example, the transmission device 31 is an internal transmission provided to the hub of the rear wheel 16. The transmission device 31 can be a continuously variable transmission.

In one example, the suspension 33 is a front suspension that is provided to the front fork 10B and that attenuates an impact applied to the front wheel 14. In another example, the suspension 33 can be a rear suspension that is provided to the frame 10A and that attenuates an impact applied to the rear wheel 16. The suspension 33 includes a motor, and can be controlled by rotating or locking the motor according to control data including a damping rate, an amount of stroke, and whether to be in a lockout state. The suspension 33 can include any one of a valve and an electromagnetic valve for controlling a flow path of oil inside the suspension 33, and can be controlled by control data including a damping rate, an amount of stroke, and whether to be in a lockout state.

The seat post 35 is mounted on the frame 10A. The seat post 35 includes a motor. The seat post 35 includes a motor to raise or lower the saddle 18 relative to the frame 10A. The seat post 35 can be controlled by rotating a motor according to control data including a support position.

The braking device 37 includes a front brake device 371 configured to brake the front wheel 14 and a rear brake device 372 configured to brake the rear wheel 16. Each of the front brake device 371 and the rear brake device 372 includes, for example, a caliper brake device or a disc brake device. Each of the front brake device 371 and the rear brake device 372 includes a motor or the like that operates the caliper brake device or the disc brake device, and can change a braking force.

The assist device 39 is a device that assists the human-powered driving force of the human-powered vehicle 1. The assist device 39 is disposed in the drive unit, for example. The assist device 39 is disposed at the battery 50, for example. The assist device 39 includes a motor. In one example, the assist device 39 is interposed between the crankshaft 21A and the frame 10A, and transmits torque to the first sprocket assembly 23 to assist the human-powered driving force to the human-powered vehicle 1. In one example, the assist device 39 assists the human-powered driving force to the human-powered vehicle 1 by driving the chain 27 that transmits the driving force to the rear wheel 16 of the human-powered vehicle 1.

The operation apparatus 40 is provided to the handlebar 12, for example. The operation apparatus 40 includes an operation device 40A to be operated by the rider. The operation device 40A includes a plurality of buttons. The plurality of buttons are provided separately to the left and right handles. The operation device 40A includes a brake lever. The operation device 40A can be operated by tilting brake levers provided to the right and left handles forward and backward.

The operation apparatus 40 includes a shift instruction device 40B. The shift instruction device 40B is, for example, a plurality of buttons included in the operation device 40A. In another example, the shift instruction device 40B is a device mounted on a brake lever. Every time the rider performs an operation such as tilting the shift instruction device 40B relative to the brake lever or pressing any of the plurality of buttons, at least one of switching of ON/OFF of automatic control for the transmission device 31 and a manual operation on the transmission device 31 can be performed. The manual operation includes at least one of increasing a gear ratio and decreasing a gear ratio. The shift instruction device 40B receives operations of increasing and decreasing the gear ratio of the first sprocket assembly 23, for example, at the right handle among the left and right handles. The shift instruction device 40B receives operations of increasing and decreasing the gear ratio of the second sprocket assembly 25 at the left handle. The shift instruction device 40B includes a button for switching ON/OFF of a synchronization setting for interlocking the gear ratio in the first sprocket assembly 23 and the gear ratio in the second sprocket assembly 25.

The operation apparatus 40 includes a suspension instruction device 40C. The suspension instruction device 40C is, for example, a button included in the operation device 40A. By pressing a button corresponding to the suspension instruction device 40C, it is possible to set control data such as the damping rate and stroke of the suspension.

The operation apparatus 40 includes a seat post instruction device 40D. The seat post instruction device 40D is, for example, a button included in the operation device 40A. By pressing a button corresponding to the seat post instruction device 40D, a saddle 351 can be raised and lowered.

The operation apparatus 40 includes a braking instruction device 40E. The braking instruction device 40E is a brake lever. By operating the brake lever, a caliper brake device or a disc brake device of the braking device 37 can be operated.

The operation apparatus 40 includes an assist instruction device 40F. The assist instruction device 40F is, for example, a button included in the operation device 40A. An assist mode can be set to any one of a plurality of stages (high/medium/low) by pressing a button corresponding to the assist instruction device 40F.

The operation apparatus 40 includes a report unit 40G that provides a report of an operation state. The report unit 40G includes a lamp and a display unit 40H that is a display. The report unit 40G can include a speaker. The display unit 40H is a display provided to the handlebar 12 of the human-powered vehicle 1. The operation apparatus 40 reports, to the rider, control states of the transmission device 31, the suspension 33, the seat post 35, the braking device 37, and the assist device 39 by using the report unit 40G. The operation apparatus 40 can also cause the report unit 40G to provide a report of the control content on the display by using a text, color, or brightness.

The operation apparatus 40 is communicably connected to the control device 100 so that a signal corresponding to an operation can be transmitted to the control device 100. The operation apparatus 40 can be communicably connected to the transmission device 31, the suspension 33, the seat post 35, the braking device 37, and the assist device 39 so that a signal corresponding to an operation can be directly output to the transmission device 31, the suspension 33, the seat post 35, the braking device 37, and the assist device 39. In a first example, the operation apparatus 40 communicates with the control device 100 via a communication line or a power line capable of power line communication (PLC). The operation apparatus 40 can communicate with the transmission device 31, the suspension 33, the seat post 35, the braking device 37, the assist device 39, and the control device 100 via a communication line or a power line capable of PLC. In a second example, the operation apparatus 40 communicates with the control device 100 by wireless communication. The operation apparatus 40 can communicate with the transmission device 31, the suspension 33, the seat post 35, the braking device 37, the assist device 39, and the control device 100 by wireless communication.

The battery 50 includes a battery body 51 and a battery holder 53. The battery body 51 is a storage battery including one or a plurality of battery cells. The battery holder 53 is fixed to the frame 10A of the human-powered vehicle 1. The battery body 51 is attachable to and detachable from the battery holder 53. The battery 50 is electrically connected to the controlled device 30, the operation apparatus 40, and the control device 100, and supplies electric power, as necessary. The battery 50 preferably includes a control unit for communicating with the control device 100. The control unit preferably includes a processor using a CPU.

The human-powered vehicle 1 includes, at various parts, a sensor 60 for acquiring information related to traveling, including the state of the rider and the traveling environment. The sensor 60 includes a speed sensor 61, an acceleration sensor 62, a torque sensor 63, a cadence sensor 64, a gyro sensor 65, a seating sensor 66, a camera 67, and a position information sensor 68.

The speed sensor 61 is provided to the front wheel 14, for example, and transmits a signal corresponding to the number of rotations per unit time of the front wheel 14 to the control device 100. The control device 100 can calculate a vehicle speed and a travel distance of the human-powered vehicle 1 based on the output of the speed sensor 61.

The acceleration sensor 62 is fixed to, for example, the frame 10A. The acceleration sensor 62 is a sensor that outputs vibration of the human-powered vehicle 1 in three axes (the front-rear direction, the left-right direction, and the up-down direction) with respect to the frame 10A, and is provided to detect motion and vibration of the human-powered vehicle 1. The acceleration sensor 62 transmits a signal corresponding to magnitude of the motion and vibration to the control device 100.

For example, the torque sensor 63 is provided so as to measure torques applied to the right crank 21B and the left crank 21C. The torque sensor 63 transmits, to the control device 100, a signal corresponding to the torque measured in at least one of the right crank 21B and the left crank 21C.

The cadence sensor 64 is provided so as to measure a cadence of one of the right crank 21B and the left crank 21C, for example. The cadence sensor 64 transmits a signal corresponding to the measured cadence to the control device 100.

The gyro sensor 65 is fixed to, for example, the frame 10A. The gyro sensor 65 is provided to detect yaw, roll, and pitch rotations of the human-powered vehicle 1. The gyro sensor 65 transmits, to the control device 100, a signal corresponding to an amount of rotation of each of the three axes. The yaw is a rotation about an axis in the up-down direction. The roll is a rotation about an axis in the front-rear direction. The pitch is a rotation about an axis in the left-right direction.

The seating sensor 66 is provided to the inner surface of the saddle 351 so as to measure whether the rider is seated on the saddle 351. The seating sensor 66 uses, for example, a piezoelectric sensor, and transmits a signal corresponding to a weight applied to the saddle 351 to the control device 100.

The camera 67 is provided to the front fork 10B so as to face forward. In a first example, the camera 67 is provided to the front fork 10B together with a light, so as to face forward. In a second example, the camera 67 is provided to the handlebar 12. The camera 67 outputs a video corresponding to the field of view of the rider by using the camera module. The camera 67 outputs a video signal obtained by capturing a video of an object existing in the travel direction.

The position information sensor 68 is fixed to, for example, the frame 10A. The position information sensor 68 is provided to detect information related to a position of the human-powered vehicle 1. For example, the position information sensor 68 is provided to detect information related to a longitude and a latitude of the human-powered vehicle 1 on the earth. For example, the position information sensor 68 is a GPS sensor. The position information sensor 68 transmits, to the control device 100, a signal corresponding to information regarding the position of the human-powered vehicle 1.

The sensor 60 need not include all of the speed sensor 61, the acceleration sensor 62, the torque sensor 63, the cadence sensor 64, the gyro sensor 65, the seating sensor 66, the camera 67, and the position information sensor 68.

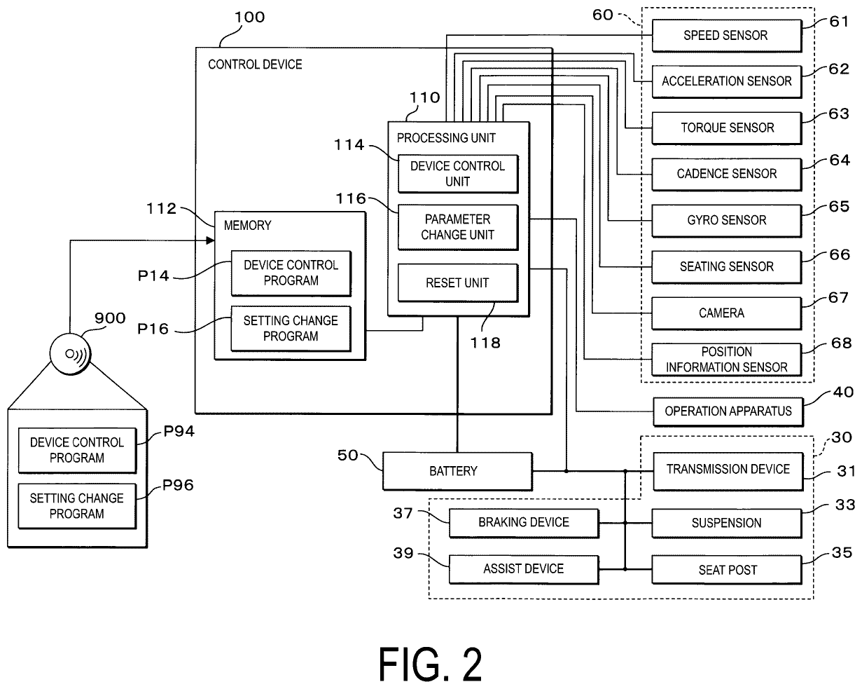

FIG. 2 is a block diagram illustrating a configuration of the control device 100. The control device 100 includes a processing unit 110 and a memory 112. The control device 100 can also be referred to as an electronic controller. The control device 100 is preferably a microcomputer that includes one or more processors and one or more computer storage devices (i.e., computer memory devices). The control device 100 is formed of one or more semiconductor chips that are mounted on a printed circuit board. The terms “control device”, “controller” and “electronic controller” as used herein refer to hardware that executes a software program, and does not include a human being.

The processing unit 110 includes at least one a processor using a central processing unit (CPU). The processing unit 110 uses a built-in memory such as a read only memory (ROM) and a random access memory (RAM). The processing unit 110 is a processor that reads information from the built-in memory and the memory 112 to execute processing. The processing unit 110 executes processing of functions separately assigned among a device control unit 114, a parameter change unit 116, and a reset unit 118.

The device control unit 114 executes automatic control processing. The device control unit 114 acquires input information regarding traveling of the human-powered vehicle 1 from the sensor 60. The device control unit 114 controls the controlled device 30 based on control data of the controlled device 30 provided to the human-powered vehicle 1 in accordance with a device control program P14. The control data is determined based on the acquired input information. The device control unit 114 determines the control data by using a predetermined control algorithm based on the acquired input information. The device control unit 114 controls an operation of a control target, which is provided to the human-powered vehicle 1, based on the determined control data in accordance with the device control program P14.

The parameter change unit 116 changes a parameter to be used for the predetermined control algorithm according to at least one of a result of an intervening operation of the rider on the automatic control by the device control unit 114 and a result of an operation on the operation apparatus 40 by the rider while the automatic control by the device control unit 114 is stopped.

The reset unit 118 resets the parameter related to the automatic control changed through learning by the parameter change unit 116 to predetermined data in a case where a predetermined condition is satisfied.

Details of processing contents by the device control unit 114, the parameter change unit 116, and the reset unit 118 will be described below.

The memory 112 includes, for example, a non-volatile memory such as a flash memory. The memory 112 stores the device control program P14 and a setting change program P16. The device control program P14 and the setting change program P16 can be obtained by the processing unit 110 reading a device control program P94 and a setting change program P96 stored in a non-transitory storage medium 900 and duplicating the device control program P94 and the setting change program P96 in the memory 112, respectively.

The memory 112 stores the parameter related to the automatic control based on the device control program P14 so as to be rewritable. The contents of the parameter related to the automatic control will be described below.

The processing unit 110 communicates with a control target. The processing unit 110 itself can include a communication unit (not illustrated) for the control target, or the processing unit 110 can be connected to a communication unit for a control target, which is provided inside the control device 100. The processing unit 110 preferably includes a connection unit for connecting to a control target or a communication unit.

The processing unit 110 preferably communicates with the control target by at least one of PLC and CAN communication. The communication performed by the processing unit 110 with the control target is not limited to wired communication, and can be wireless communication such as ANT®, ANT+®, Bluetooth®, Wi-Fi®, or ZigBee®.

The processing unit 110 is connected to the sensor 60 via a signal line. The processing unit 110 acquires input information regarding the traveling of the human-powered vehicle 1 from the signal output by the sensor 60 via the signal line.

Contents of control by the control device 100 configured as described above will be described. On the human-powered vehicle 1, the rider can switch ON/OFF of the automatic control for the controlled device 30 included in the operation apparatus 40, and can perform, regardless of whether the automatic control is ON or OFF, a manual operation (an intervening operation in a case where the automatic control is ON) on the controlled device 30.

In the case where the automatic control is ON, the processing unit 110 of the control device 100 determines the control data by the function of the device control unit 114, and controls the controlled device 30 by giving the control data to the controlled device 30. The processing unit 110 determines the control data based on a comparison between the input information input by the sensor 60 and setting data stored in the memory 112 in accordance with the device control program P14. Hereinafter, the control target will be described as the transmission device 31.

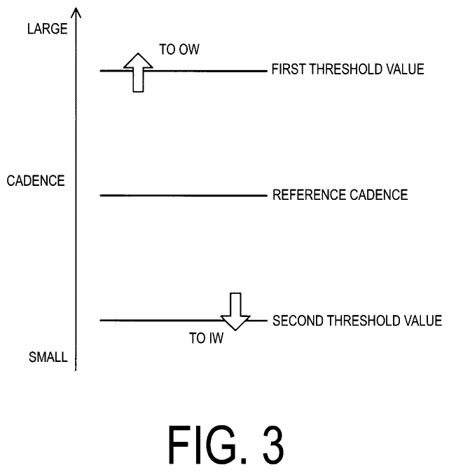

In a case where the automatic control is ON, the control device 100 compares a cadence obtained by the cadence sensor 64 with a parameter set between an upper limit value and a lower limit value, determines a gear ratio according to a range within which the cadence is, and controls the transmission device 31. To be specific, the control device 100 determines the gear ratio such that a cadence during traveling remains in the vicinity of a reference cadence set between the upper limit value and the lower limit value, and controls the transmission device 31 (FIG. 3).

In the case where the automatic control is ON, the control device 100 can determine the number of front and rear stages in the transmission device 31 in a case where the speed acquired by the speed sensor 61 is determined to be a speed at a start time of the transition from a stopped state to a state to start traveling, and can control the transmission device 31.

In the case where the automatic control is ON, the control device 100 can compare a torque acquired from the torque sensor 63 with parameters of an upper limit value and a lower limit value, determine a gear ratio according to a range within which the torque is, and control the transmission device 31.

In the case where the automatic control is ON, the control device 100 can compare a power calculated based on the cadence acquired from the cadence sensor 64 and the torque acquired from the torque sensor 63 with the parameters of an upper limit value and a lower limit value, determine a gear ratio according to a range within which the power is, and control the transmission device 31.

FIG. 3 is a schematic diagram of a control algorithm of the transmission device 31 by the device control unit 114. In the schematic diagram illustrated in FIG. 3, a control algorithm will be described as an example, the control algorithm being for performing control such that the cadence of the crank 21 during traveling remains in the vicinity of a reference cadence set between an upper limit value and a lower limit value. FIG. 3 illustrates a criteria for changing the gear ratio relative to the cadence obtained from the cadence sensor 64. The vertical direction indicates magnitude of the cadence. The upper side of FIG. 3 illustrates a larger cadence. The device control unit 114 determines the gear ratio by comparing the cadence with a threshold value included in the setting data. For example, in a case where the cadence acquired from the cadence sensor 64 reaches a value equal to or more than a first threshold value that is larger than the reference cadence, the device control unit 114 determines to change the gear ratio to a higher gear ratio side OW (Outward). On the other hand, in a case where the cadence obtained from the cadence sensor 64 reaches a value equal to or less than a second threshold value that is lower than the reference cadence, the device control unit 114 determines to change the gear ratio to a lower gear ratio side IW (Inward). The device control unit 114 performs control such that the cadence remains in the vicinity of the reference cadence even after the gear ratio is changed.

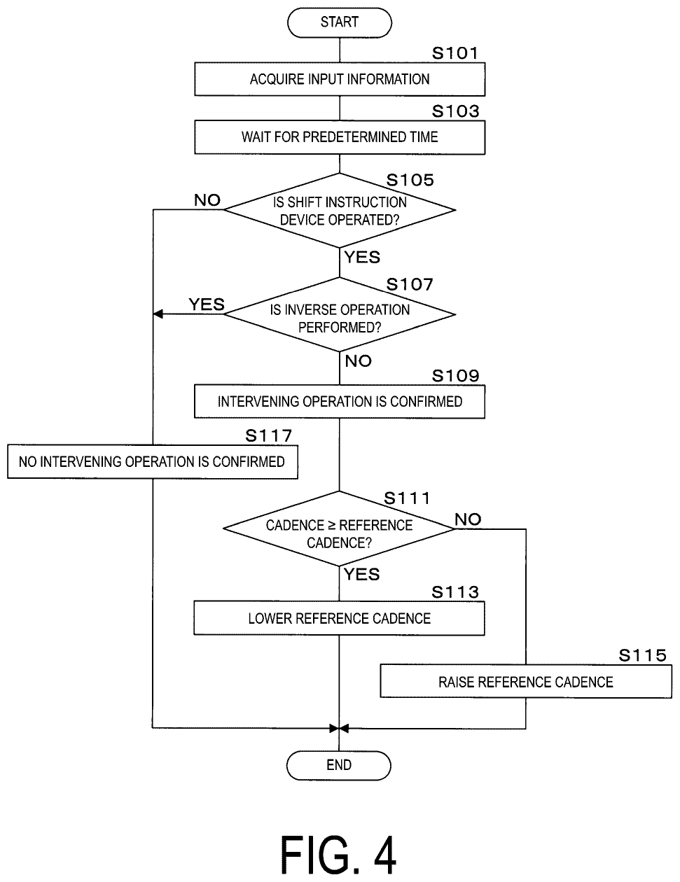

The memory 112 of the control device 100 stores the reference cadence, the first threshold value, and the second threshold value, which have been described above, so as to be rewritable as parameters. The parameter change unit 116 updates these parameters, as necessary. FIG. 4 is a flowchart illustrating an example of a change procedure of a control parameter. The parameter change unit 116 executes the following processing based on the setting change program P16 in a state where the automatic control is being performed by the device control unit 114.

The parameter change unit 116 acquires input information from the sensor 60 (step S101), waits for a predetermined time (for example, 1 to 3 seconds) (step S103), and determines whether the shift instruction device 40B is operated (step S105).

In step S101, for the input information such as a cadence, a torque, a vehicle speed, an acceleration, and an inclination, which can be acquired from the sensor 60, the parameter change unit 116 continues to buffer, in the RAM, data corresponding to a predetermined period (for example, 5 seconds or the like) from the latest time.

In a case where the shift instruction device 40B is determined to be operated (S105: YES), the parameter change unit 116 determines whether an inverse operation of the operation in step S105 is performed on the shift instruction device 40B, shortly after the operation in step S105 (for example, within two seconds) (step S107).

In a case where it is determined that the inverse operation has not been performed (S107: NO), the parameter change unit 116 determines that an intervening operation is performed (there is an operation) (step S109). At a timing when it is determined in step S107 that the inverse operation has not been performed, the input information can be acquired after the elapse of a predetermined time.

The parameter change unit 116 determines whether the cadence acquired from the cadence sensor 64 is equal to or more than the reference cadence (step S111). In a case where the cadence is determined to be equal to or more than the reference cadence (YES in S111), the rider intends to change the gear ratio in a state where the cadence is increasing. Thus, the parameter change unit 116 lowers the reference cadence, which is one parameter related to the automatic control, to facilitate control for increasing the gear ratio (weighing control) with the cadence (step S113). In step S113, the parameter change unit 116 can lower the first threshold value (upper limit value) instead of lowering the reference cadence. The processing unit 110 ends the change processing of the parameter related to the automatic control.

In a case where in step S111, the cadence is determined to be less than the reference cadence (NO in S111), the rider intends to change the gear ratio in a state where the cadence is lowering. Thus, the parameter change unit 116 raises the reference cadence, which is one parameter related to the automatic control, to facilitate control for decreasing the gear ratio (lightening control) with the cadence (step S115). In step S115, the parameter change unit 116 can raise the second threshold value (lower limit value) instead of raising the reference cadence. The processing unit 110 ends the change processing of the parameter related to the automatic control.

The parameter change unit 116 can discretely execute the lowering of the reference cadence in step S113 and the raising of the reference cadence in step S115, instead of continuously changing the reference cadence by adding+1 rpm (revolutions per minute) or the like. In a case where the reference cadence is initially 75 rpm, the parameter change unit 116 lowers “75” to “70”.

In a case where it is determined in step S105 that the shift instruction device 40B has not been operated (NO in S105), or it is determined in step S107 that the inverse operation is performed (YES in S107), it is confirmed that the intervening operation has not been performed (there has been no operation) (step S117), and the parameter change unit 116 ends the processing.

In this manner, the automatic control performed by the device control unit 114 is optimized in accordance with the rider's intention to drive the human-powered vehicle 1 according to the situation. The parameter related to the automatic control, which is changed by the above-described parameter change unit 116, is at least one of the reference cadence, the first threshold value, and the second threshold value. Without being limited thereto, the parameter change unit 116 can change (relearn) the learning model, which has been learned to output the control data in a case where the input information is input, so as to be optimized for the rider.

The control device 100 changes the parameter as illustrated in FIG. 4, but in a case where a predetermined condition is satisfied, the control device 100 resets the parameter related to the automatic control, which has been learned, to predetermined data. In the first embodiment, the control device 100 determines a condition that the reset unit 118 performs a specific operation on the operation device 40A as the predetermined condition, and performs resetting in a case where the specific operation is performed. The predetermined condition is not limited to this.

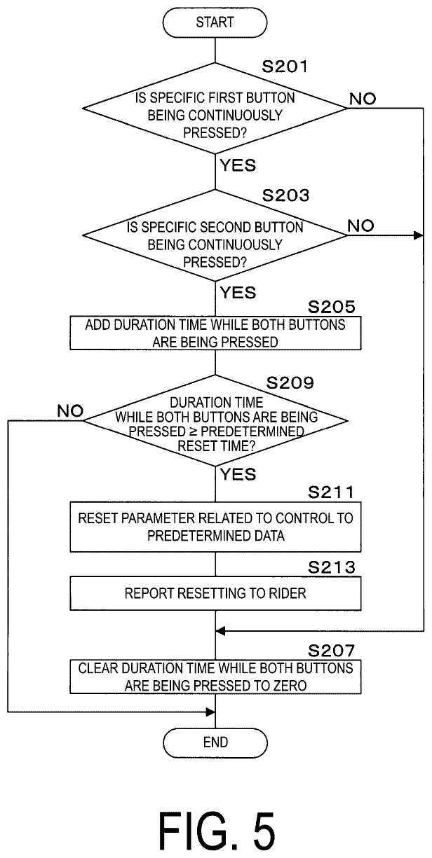

FIG. 5 is a flowchart illustrating an example of a reset processing procedure of a control parameter. The reset unit 118 executes the following processing at a predetermined cycle (for example, 100 milliseconds, 1 second, or the like) based on the setting change program P16 together with the setting change by the parameter change unit 116 executed in parallel with the automatic control by the device control unit 114.

The reset unit 118 determines whether a specific first button included in the operation device 40A is continuously being pressed (step S201), and determines whether a specific second button is also continuously being pressed (step S203).

In a case where the reset unit 118 determines that the specific first button is continuously being pressed (YES in S201), and determines that the specific second button is also continuously being pressed (YES in S203), the reset unit 118 adds a duration time while both buttons are being pressed (step S205). In step S205, the reset unit 118 can add an actual time corresponding to the predetermined cycle, or can simply add, in a predetermined unit, a count corresponding to the number of times both buttons are determined to be continuously being pressed.

In a case where the reset unit 118 determines in step S201 that the specific first button is not continuously being pressed (NO in S201), the reset unit 118 clears the duration time while both buttons are being pressed to zero (step S207) and ends the processing. Even in a case where the specific first button is continuously being pressed (YES in S201), in a case where the reset unit 118 determines in step S203 that the specific second button is not continuously being pressed (NO in S203), the reset unit 118 clears the duration time while both buttons are being pressed to zero (S207) and ends the processing.

In a case where both the first button and the second button are determined to be continuously being pressed (YES in S201, YES in S203), the reset unit 118 determines whether the duration time while both buttons are being pressed, which has been added in step S205, is equal to or longer than a predetermined reset time (step S209).

In a case where the duration time while both buttons are being pressed is determined to be equal to or longer than the reset time (YES in S209), the reset unit 118 resets the parameter related to the automatic control to predetermined data (step S211). In step S211, the reset unit 118 resets the above-described reference cadence to a predetermined value stored in the memory 112. The reset unit 118 can reset the first threshold value and the second threshold value, together with the reference cadence, to initial values stored in the memory 112.

In a case where resetting is performed, the reset unit 118 reports the resetting to the rider by using the report unit 40G (step S213). In step S213, the reset unit 118 causes the display of the report unit 40G to display a text, a color, or a brightness for reporting the resetting. In step S213, in order to report the resetting, the reset unit 118 can make the color of an indicator such as a lamp or an LED light up in green, for example, or can control the brightness of the lamp or the LED to blink.

After reporting the resetting, the reset unit 118 clears the duration time while both buttons are being pressed to zero (S207), and ends the reset processing.

In a case where the duration time while both buttons are being pressed is determined to be less than the reset time (NO in S209), the reset unit 118 ends the processing and waits until the next cycle comes around.

The predetermined condition for resetting by the reset unit 118 as illustrated in FIG. 5 is not limited to the above-described predetermined operation on the operation device 40A. A reset button can be provided to the operation device 40A, and whether the reset button is pressed can be detected. For example, the predetermined condition can be a condition corresponding to a case where a stop period of the human-powered vehicle 1 is equal to or longer than a predetermined period such as several days or one week. The predetermined condition can be detection of a change of the rider. The fact that the rider has changed can be determined in a case where a weight that can be detected by the seating sensor 66 is different. The reset unit 118 can determine that the predetermined condition is satisfied and perform resetting in a case where the operation device 40A receives the change of the rider.

Through the above-described processing, the parameter optimized (learned) in the human-powered vehicle 1 for the rider can be reset in a case where a predetermined operation is performed. The rider riding on the human-powered vehicle 1 can reset the parameter in a case where the optimization of the parameter becomes different from the rider's intention. In a case where another rider gets on the human-powered vehicle 1 and starts driving, the parameter related to the automatic control that has been learned so far can be reset.

The control device 100 reports the resetting by the report unit 40G, resulting in causing the rider to recognize that the automatic control is reset.

### Second Embodiment

In a second embodiment, the reset operation is performed by an information terminal device carried by a rider, and the report of the resetting is also performed on the information terminal device.

A configuration of the human-powered vehicle 1 and a configuration of the control device 100 according to the second embodiment are similar to those according to the first embodiment except for a processing procedure, which will be described below. Therefore, the same components of the human-powered vehicle 1 and the control device 100 according to the second embodiment as those of the first embodiment are denoted by the same signs, and detailed description thereof will be omitted.

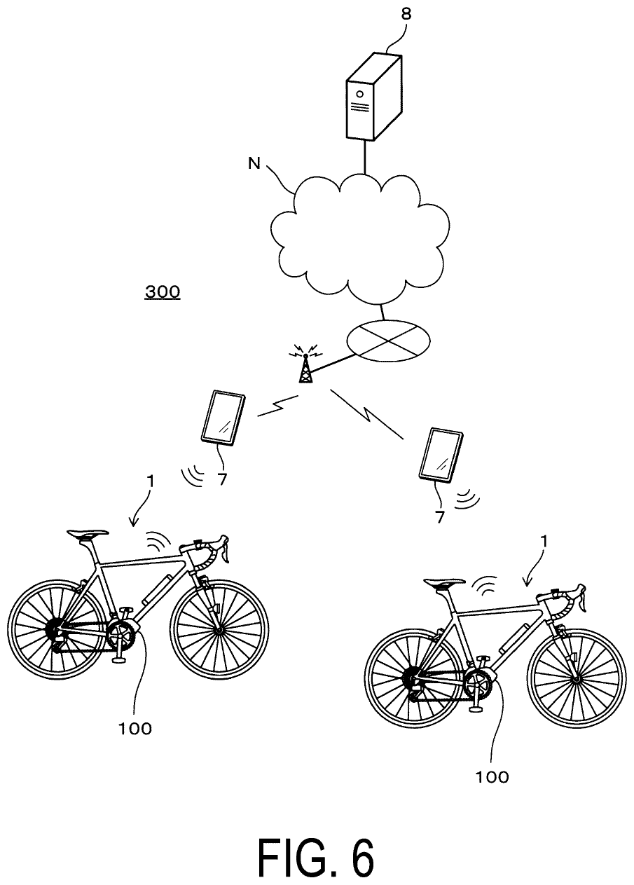

FIG. 6 is a diagram illustrating a human-powered vehicle control system 300. The human-powered vehicle control system 300 includes the control devices 100 provided to the respective human-powered vehicles 1, information terminal devices 7 used by the riders, and a server device 8 that performs data transmission and reception with the information terminal devices 7. The information terminal device 7 can be worn by the rider himself/herself or can be included in his/her belongings. The information terminal device 7 can be provided to the handlebar 12 of the human-powered vehicle 1.

As illustrated in FIG. 6, the control device 100 according to the second embodiment can communicate with the information terminal device 7 through a wireless communication device 120. The information terminal device 7 can communicate with the server device 8 via a communication network N. The communication network N includes telecommunication links and lines such as 3G, 4G, 5G, LTE, WAN, LAN, Internet lines, dedicated lines, and a satellite communication link and communication apparatuses such as base stations. The information terminal device 7 is, for example, a smartphone, a cycle computer, or the like used by the rider of the human-powered vehicle 1, and can also function as a user interface that inputs an instruction from the rider and that outputs information to the rider. That is, the information terminal device 7 possessed by the rider can be used as the operation device 40A.

The control device 100 can output the parameter related to the control that has been changed by the parameter change unit 116 to the server device 8 through the information terminal device 7 of the rider in association with a rider ID for identifying the rider, and cause the server device 8 to store the parameter. This also enables the parameter to be changed for the rider to be applied to another human-powered vehicle 1.

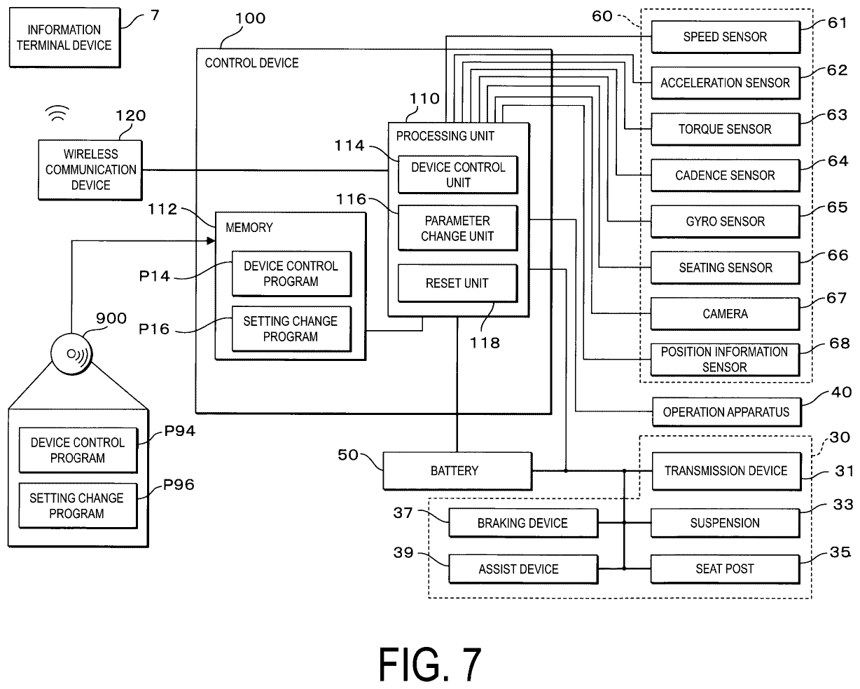

FIG. 7 is a block diagram illustrating a configuration of the control device 100 in the second embodiment. In the second embodiment, the processing unit 110 of the control device 100 can communicate with the information terminal device 7 of the rider through the wireless communication device 120 including an antenna. The wireless communication device 120 can be built in the control device 100. The wireless communication device 120 is a device that achieves communication via the so-called Internet. The wireless communication device 120 can be a device for wireless communication such as ANT®, ANT+®, Bluetooth®, Wi-Fi®, ZigBee®, or Long Term Evolution (LTE). The wireless communication device 120 can be compliant with a communication network such as 3G, 4G, 5G, Long Term Evolution (LTE), a Wide Area Network (WAN), a Local Area Network (LAN), Internet lines, dedicated lines, or a satellite communication system.

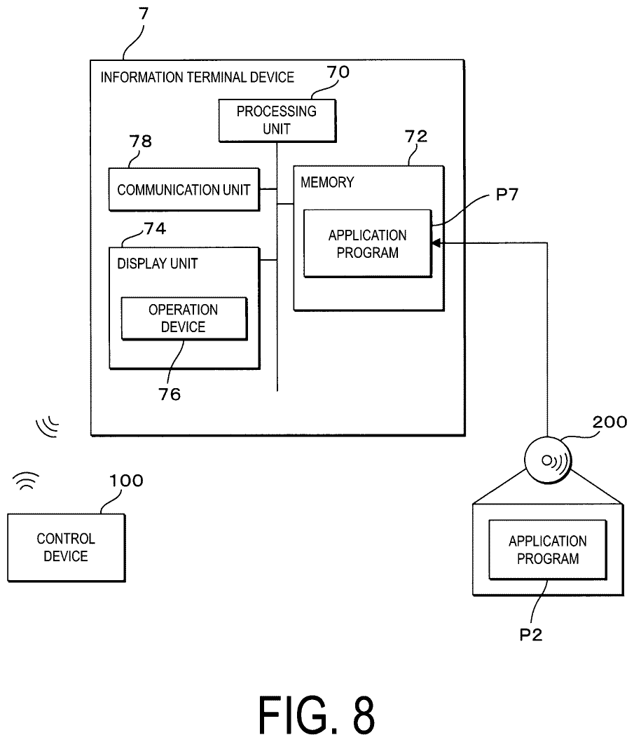

FIG. 8 is a block diagram illustrating a configuration of the information terminal device 7. The information terminal device 7 includes a processing unit 70, a memory 72, a display unit 74, and a communication unit 78. The information terminal device 7 is, for example, a smartphone or a tablet terminal. The information terminal device 7 is not limited to a smartphone or a tablet terminal as long as the information terminal device 7 includes a processing unit, a display unit (operation device), and a communication unit and cooperates with the human-powered vehicle 1. The information terminal device 7 can be at least one of a personal computer, a wearable device, and a cycle computer.

The processing unit 70 includes at least one processor using a central processing unit (CPU). The processing unit 70 uses a built-in memory such as a ROM and a RAM. The processing unit 70 controls communication with the control device 100 of the human-powered vehicle 1 in accordance with an application program P7, which will be described below.

The memory 72 includes, for example, a non-volatile memory such as a flash memory. The memory 72 stores the application program P7. The application program P7 can be obtained by the processing unit 70 reading an application program P2 stored in a non-transitory storage medium 200 and duplicating the application program P2 in the memory 72, or can be obtained by downloading the application program P2 through a public network.

The display unit 74 is a display device such as a liquid-crystal panel or an organic electroluminescent (EL) display. The display unit 74 displays information output from the processing unit 70. In the first embodiment, the display unit 74 displays a screen for receiving a setting for the human-powered vehicle 1 based on the application program P7.

The display unit 74 includes an operation device 76 that is an interface for receiving a user operation. In the present embodiment, the operation device 76 is a touch panel device included in the display unit 74. The operation device 76 can be a physical button, a touch panel device with a built-in display, a speaker, a microphone, or the like.

The communication unit 78 includes an antenna and can wirelessly communicate with the control device 100. The communication unit 78 is a device compatible with the wireless communication device 120 in compliance with a protocol capable of communicating with the control device 100.

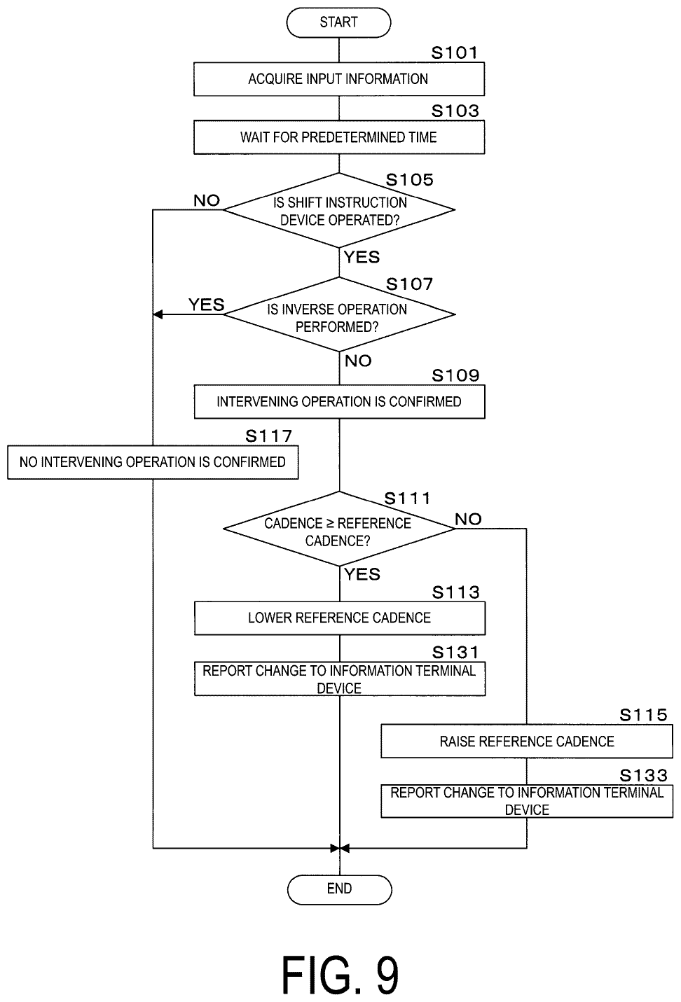

In the second embodiment, after activation, the control device 100 controls the wireless communication device 120 to establish a wireless communication connection with the information terminal device 7 and executes processing. FIG. 9 is a flowchart illustrating an example of a change procedure of a control parameter according to the second embodiment. In the processing procedure illustrated in FIG. 9, the same step numbers are assigned to the same procedures as those in the processing procedure illustrated in FIG. 4 of the first embodiment, and detailed description thereof will be omitted.

In the second embodiment, in a case where the reference cadence, which is one of the parameters related to the automatic control, is lowered (S113), the control device 100 causes the wireless communication device 120 to report the change to the information terminal device 7 (step S131). Even in a case where the reference cadence is raised (S115), the control device 100 causes the wireless communication device 120 to report the change to the information terminal device 7 (step S133). The content of the report to the information terminal device 7 can be, for example, a text such as “The parameter of the transmission device is changed”, or can be a color such as blue at the time of the raising and red at the time of the lowering.

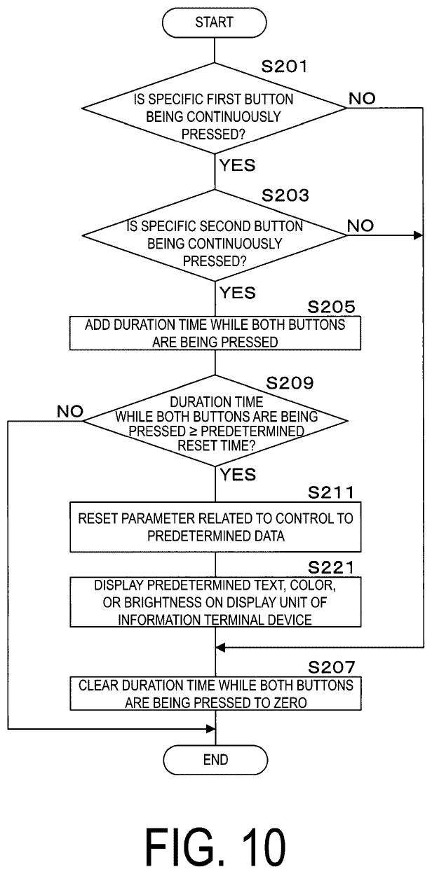

FIG. 10 is a flowchart illustrating an example of a reset processing procedure of the control parameter according to the second embodiment. In the processing procedure illustrated in FIG. 10, the same step numbers are assigned to the same procedures as those in the processing procedure illustrated in FIG. 5 of the first embodiment, and detailed description thereof will be omitted.

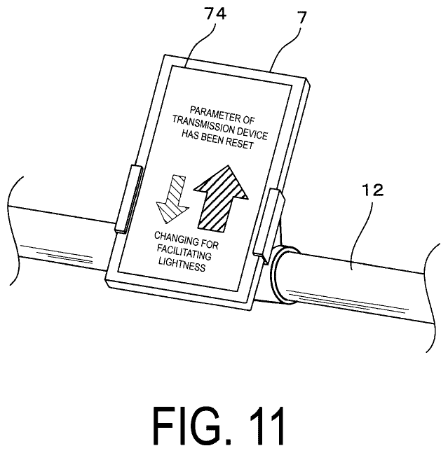

In the second embodiment, in a case where the parameter related to the automatic control is reset to predetermined data (S211), the reset unit 118 causes the display unit 74 of the information terminal device 7 of the rider to display a predetermined text, color, or brightness in order to report the resetting to the rider (step S221). In step S221, the reset unit 118 displays the text such as “The parameter of the transmission device has been reset” (see FIG. 11).

FIG. 11 is a diagram illustrating a display example on the display unit 74 of the information terminal device 7. The information terminal device 7 is fitted to a holder mounted on the handlebar 12. As described with reference to FIG. 10, the display unit 74 of the information terminal device 7 displays the text “The parameter of the transmission device has been reset”, and a color and graphic such as blue in a case where the parameter is increasing and red in a case where the parameter is decreasing. In FIG. 11, the colors of blue and red are indicated by different hatchings. In FIG. 11, a text indicating that the lower limit or the reference cadence of the transmission device 31 is increasing and the control for lowering the gear ratio (lightening control) is likely to be performed is illustrated. In this way, the setting of the automatic control for the human-powered vehicle 1 can be reset. Moreover, the rider can be made to recognize that the setting has been reset.

### Third Embodiment

In a third embodiment, as the parameter change unit 116, the control device 100 uses an operation probability output model M1 for outputting a probability indicating a possibility that an operation is performed, the possibility being as to whether a rider wants to perform manual driving instead of automatic control during traveling of the human-powered vehicle 1. Then, the control device 100 changes the parameter in a case where the probability is high.

The configuration of the human-powered vehicle 1 and the configuration of the control device 100 according to the third embodiment are similar to the configurations of the human-powered vehicle 1 and the control device 100 according to the first embodiment except for the processing procedure, which will be described below. Therefore, the same components of the human-powered vehicle 1 and the control device 100 according to the third embodiment as those of the first embodiment are denoted by the same signs, and detailed description thereof will be omitted. Also in the third embodiment, a case will be described in which a control target of the device control unit 114 is the transmission device 31, and the parameter change unit 116 changes a reference cadence, a first threshold value, and a second threshold value. However, the control target and the parameter are not limited thereto.

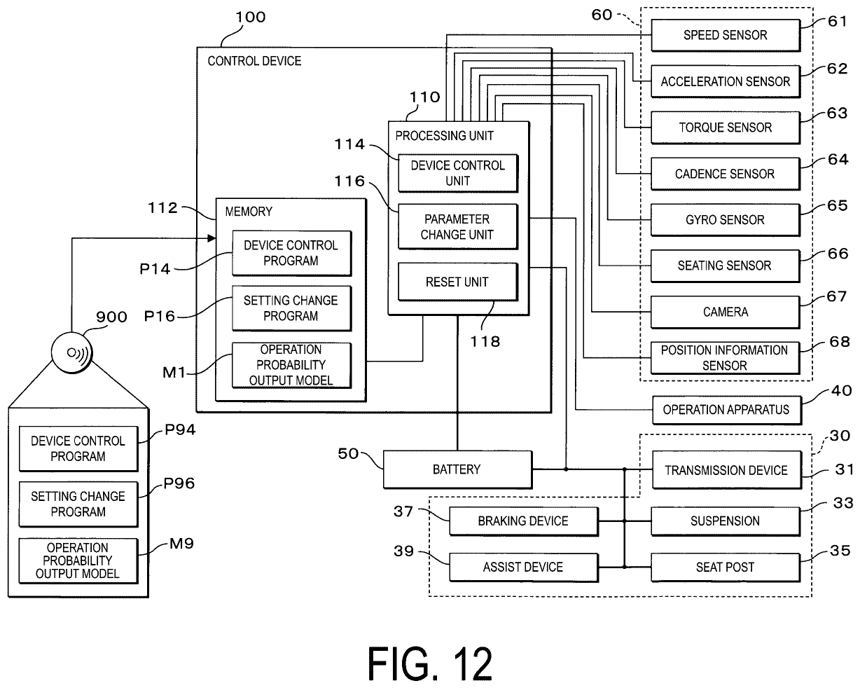

FIG. 12 is a block diagram illustrating the configuration of the control device 100 according to the third embodiment. In the third embodiment, the processing unit 110 stores the operation probability output model M1 in the memory 112. The operation probability output model M1 can be obtained by the processing unit 110 reading an operation probability output model M9 stored in the non-transitory storage medium 900 and duplicating the operation probability output model M9 in the memory 112.

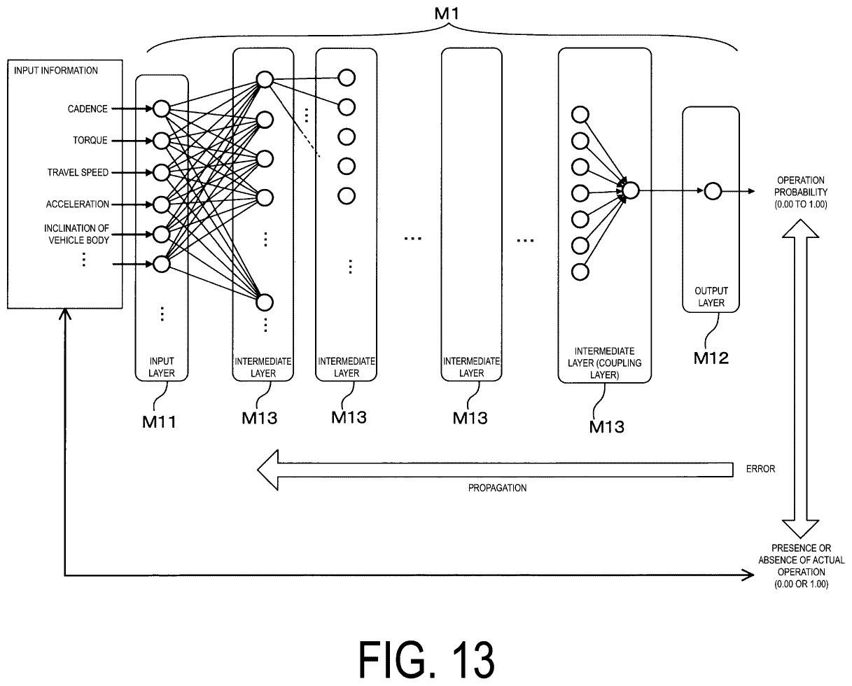

FIG. 13 is a schematic diagram of the operation probability output model M1. The operation probability output model M1 is a learning model learned by supervised deep learning using a neural network (hereinafter, referred to as NN). The operation probability output model M1 can be a model learned by a recurrent neural network. The operation probability output model M1 is learned by the processing unit 110 functioning as the learning unit so as to output a “probability that the rider will perform the intervening operation after several seconds” in a case where the input information, acquired by the sensor 60, of the traveling of the human-powered vehicle 1 is input.

The operation probability output model M1 includes an input layer M11 for inputting input information, an output layer M12 for outputting a probability that the rider will perform the intervening operation, and an intermediate layer M13 including a node group constituted by one or more layers. The intermediate layer M13 connected to the output layer M12 is a coupling layer that aggregates a large number of nodes into a certain number of nodes of the output layer M12. The number of nodes in the output layer M12 is one. Each node of the intermediate layer M13 has a parameter including at least one of a weight and a bias in relation to a node of a preceding layer. The operation probability output model M1 is learned by training data including input information such as a cadence, a torque, a travel speed, an acceleration, and an inclination, which can be acquired from the sensor 60 during traveling of the human-powered vehicle 1, and an output label (0 for absence, 1 for presence) indicating the presence or absence of an intervening operation on the transmission device 31 by the rider after a predetermined time from the acquisition of the input information. The operation probability output model M1 is learned by reversely propagating, to the intermediate layer M13, an error between a numerical value output from the output layer M12 in a case where input information in training data is input to the input layer M11 and the label associated with the input information in the training data, and updating a parameter in a node of the intermediate layer M13.

In the operation probability output model M1, not only input information such as a cadence, a torque, a travel speed, an acceleration, and an inclination, which can be acquired from the sensor 60, is directly input to the input layer value M11 at each time point, but also an amount of change in the last several seconds (for example, two seconds) can be input. The operation probability output model M1 can be learned so as to output the operation probability while being influenced by input information input back in the past by the RNN.

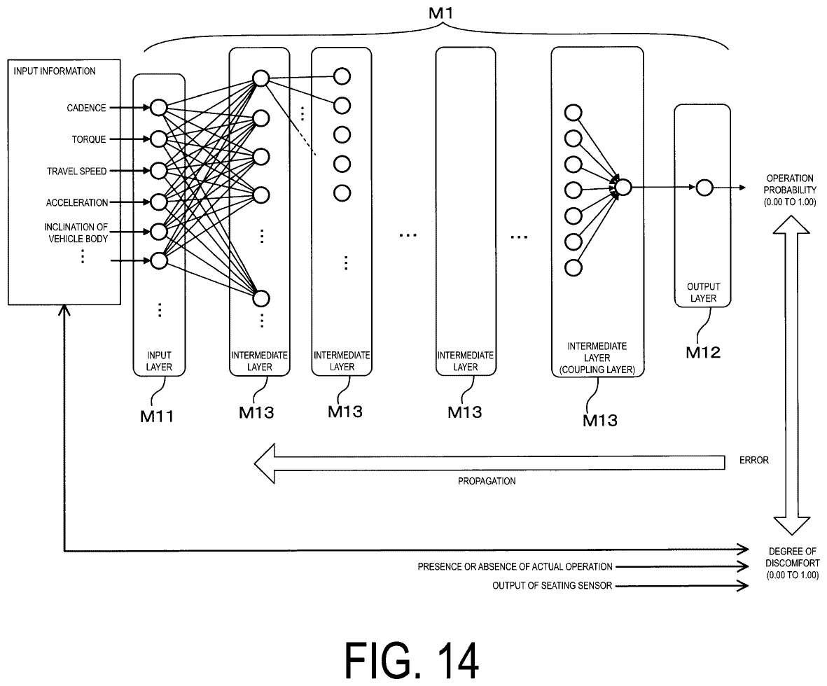

The operation probability output model M1 can be learned by using, as the label of the output, a value corresponding to the degree of discomfort of the rider after a predetermined time from the acquisition of the input information. FIG. 14 is a schematic diagram illustrating another learning method of the operation probability output model M1. As illustrated in FIG. 14, similarly to the operation probability output model M1 illustrated in FIG. 13, the operation probability output model M1 is learned so as to output “the probability that the rider will perform the intervening operation after several seconds” in a case where the input information regarding the traveling of the human-powered vehicle 1 acquired by the sensor 60 is input. The operation probability output model M1 of another example illustrated in FIG. 14 is learned by using training data including input information such as a cadence, a torque, a travel speed, an acceleration, and an inclination, which can be acquired from the sensor 60, and a value (0 to 1), as a label, corresponding to the degree of discomfort of the rider after a predetermined time from the acquisition of the input information. The operation probability output model M1 illustrated in FIG. 14 is learned by reversely propagating, to the intermediate layer M13, an error between a numerical value (0 to 1) output from the output layer M12 in a case where input information in training data is input to the input layer M11 and a label (0 to 1) of the degree of discomfort corresponding to the input information in the training data, and updating a parameter in a node of the intermediate layer M13.

The degree of discomfort of the rider is derived based on at least one of magnitude of the cadence of the human-powered vehicle 1, magnitude of the torque of the human-powered vehicle 1, a seating state of the rider, and biometric information of the rider. The processing unit 110 functioning as the learning unit derives a higher degree of discomfort as the cadence is larger, derives a higher degree of discomfort as the torque is larger, and derives a higher degree of discomfort in a case where the rider is not seated. This is because, in a case where the rider is not seated, that is, the rider is standing up and pedaling, the rider cannot keep pedaling the human-powered vehicle 1 unless the rider drives the human-powered vehicle 1 with considerable force. The processing unit 110 derives a high degree of discomfort in a case where the rider is not seated and at least one of the travel speed, the cadence, and the torque is smaller than a predetermined threshold value. This is because, in a case where the rider is not seated and the travel speed or the input to the pedal is lower than the predetermined threshold value, there is a high possibility where the rider has gotten off from the human-powered vehicle 1. The processing unit 110 functioning as the learning unit can derive a higher degree of discomfort as a pulse is faster and a blood flow is increased. The processing unit 110 can derive the degree of discomfort by a function for calculating the degree of discomfort using at least one of the cadence, the torque, the presence or absence of seating, and the biometric information as a variable. The processing unit 110 can derive a higher degree of discomfort as the stability of the human-powered vehicle 1 is lower. The processing unit 110 can derive the stability of the human-powered vehicle 1 to be lower as the inclination of the human-powered vehicle 1 calculated by at least one of the acceleration sensor 62 and the gyro sensor 65 is larger.

According to the learning method illustrated in FIG. 14, even in a case where the rider feels discomfort in the automatic control by the device control unit 114 but does not actually perform the operation, the operation probability output model M1 can be learned by setting the degree of discomfort as the label corresponding to the level of possibility of executing the intervening operation.

The operation probability output model M1 illustrated in any one of FIGS. 13 and 14 needs to be learned for each rider, and thus is stored in the memory 112 in a state of being learned to some extent before shipment of the control device 100. After the human-powered vehicle 1 is shipped and purchased, the parameter change unit 116, as the learning unit of the control device 100, proceeds with learning of the operation probability output model M1 for each rider.

By using the learned operation probability output model M1, the parameter change unit 116 can predict whether the intervening operation will be performed by the rider after several seconds based on the input information corresponding to the travel state of the human-powered vehicle 1. The parameter change unit 116 decides the control data by the control algorithm as illustrated in FIG. 3 of the first embodiment based on the input information acquired from the sensor 60. The parameter change unit 116 changes the parameter of the predetermined control algorithm in a case where the probability of the rider performing the intervening operation on the automatic control of the transmission device 31 can be determined to be equal to or more than a predetermined value by using the learned operation probability output model M1.

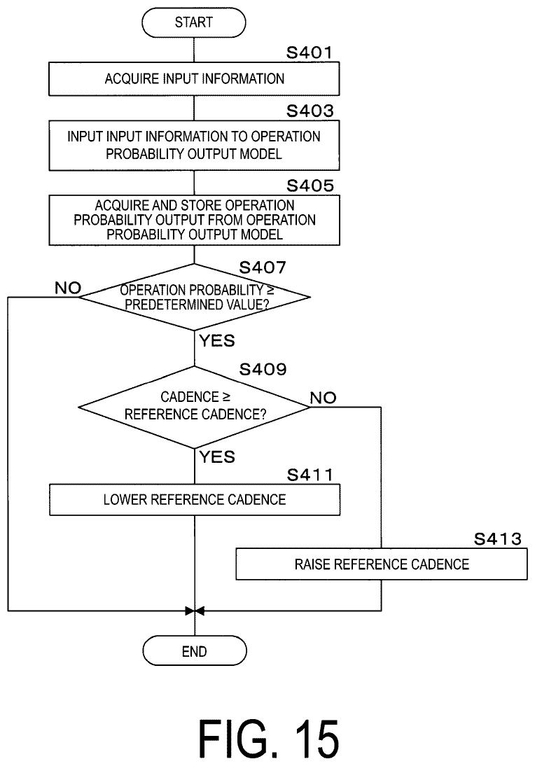

FIG. 15 is a flowchart illustrating an example of a change procedure of a control parameter according to the third embodiment. The parameter change unit 116 executes the following processing based on the setting change program P16 in a state where the automatic control is being performed by the device control unit 114.

The parameter change unit 116 acquires input information from the sensor 60 (step S401), and inputs the acquired input information to the learned operation probability output model M1 (step S403). The parameter change unit 116 acquires the operation probability acquired from the operation probability output model M1, and stores the operation probability in time-series order (step S405).

The parameter change unit 116 determines whether the operation probability acquired from the operation probability output model M1 stored in step S405 is equal to or more than a predetermined value (step S407). In a case where the operation probability is determined to be equal to or more than the predetermined value (YES in S407), the parameter change unit 116 determines whether the cadence is equal to or more than the reference cadence (step S409).

In a case where the cadence is determined to be equal to or more than the reference cadence (YES in S409), the parameter change unit 116 lowers the reference cadence, which is one of the parameters for determining the gear ratio of the transmission device 31 (step S411). In step S411, the parameter change unit 116 can lower the first threshold value (upper limit) instead of lowering the reference cadence. The parameter change unit 116 can report, from the report unit 40G, the fact that the parameter has been changed. The parameter change unit 116 ends the change processing of the parameter.

In a case where in step S409, the cadence is determined to be less than the reference cadence (NO in S409), the parameter change unit 116 raises the reference cadence, which is one of the parameters for determining the gear ratio of the transmission device 31 (step S413). In step S411, the parameter change unit 116 can raise the second threshold value (lower limit) instead of raising the reference cadence. The parameter change unit 116 can report the fact that the reference cadence has been raised, from the report unit 40G. The parameter change unit 116 ends the change processing of the parameter.

In a case where in step S407, the operation probability is determined to be less than the predetermined value (NO in S407), the parameter change unit 116 ends the processing because there is a low possibility that the rider will perform the intervening operation.

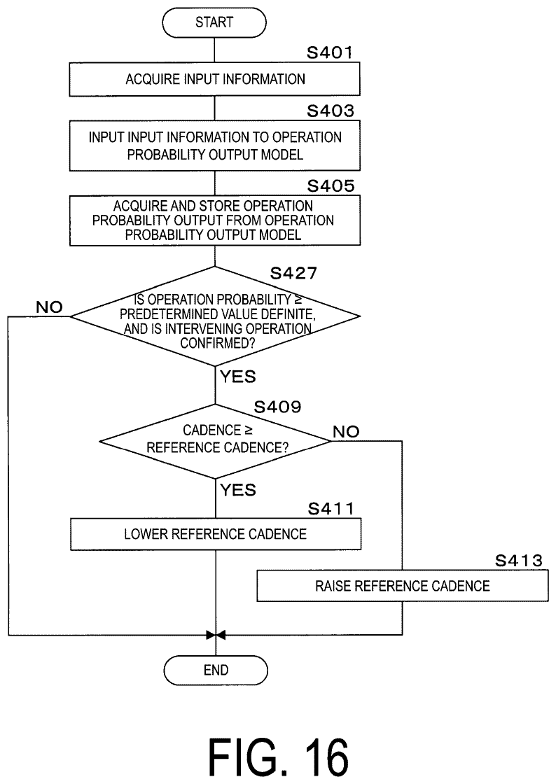

The parameter change unit 116 can change the parameter after confirming the fact that the intervening operation has been reliably performed. The parameter change unit 116 changes the parameter in a case where the probability output from the operation probability output model M1 is determined to be equal to or more than the predetermined value and it is confirmed that the intervening operation has been performed. FIG. 16 is a flowchart illustrating another example of the change procedure of the control parameter in the third embodiment. In the processing procedure illustrated in FIG. 16, the same step numbers are assigned to the same procedures as those in the processing procedure illustrated in FIG. 15, and detailed description thereof will be omitted.

In the other example, the parameter change unit 116 acquires and stores an operation probability from the operation probability output model M1 (S405), and then determines whether the operation probability is definitely equal to or more than a predetermined value, and whether the intervening operation has been confirmed at the shift instruction device 40B (step S427).

The determination processing as to whether the operation probability acquired from the operation probability output model M1 in step S427 is definitely equal to or more than the predetermined value is executed by, for example, the parameter change unit 116 determining whether the probability output from the operation probability output model M1 is at a peak in a time-series manner and is equal to or more than the predetermined value. For example, in a case where it is determined that the operation probability stored in the time-series order in step S405 is the highest in a predetermined period such as 3 to 5 seconds and is, for example, equal to or more than 40%, the parameter change unit 116 determines that the operation probability is definitely equal to or more than the predetermined value.

The determination processing as to whether the intervening operation has been confirmed at the shift instruction device 40B in step S427 is executed by the parameter change unit 116 based on whether the intervening operation has been performed on the transmission device 31 by the rider using the shift instruction device 40B and a different intervening operation (an inverse intervening operation) has not been performed on the shift instruction device 40B within a predetermined time from the intervening operation (see step S117 in FIG. 4). For example, in a case where the intervening operation is performed on the shift instruction device 40B after the input information is acquired in step S101, the parameter change unit 116 can determine that the intervening operation is confirmed in a case where it is determined that the inverse intervening operation is not performed within one second.

In a case where it is determined that the operation probability acquired from the operation probability output model M1 is definitely equal to or more than the predetermined value and that the intervening operation has been confirmed at the shift instruction device 40B (YES in S427), the parameter change unit 116 proceeds the processing to step S409.

In step S427, in a case where the operation probability is equal to or more than the predetermined value is not definite, or in a case where the intervening operation by the shift instruction device 40B has not been confirmed (NO in S427), the parameter change unit 116 ends the processing without doing anything.

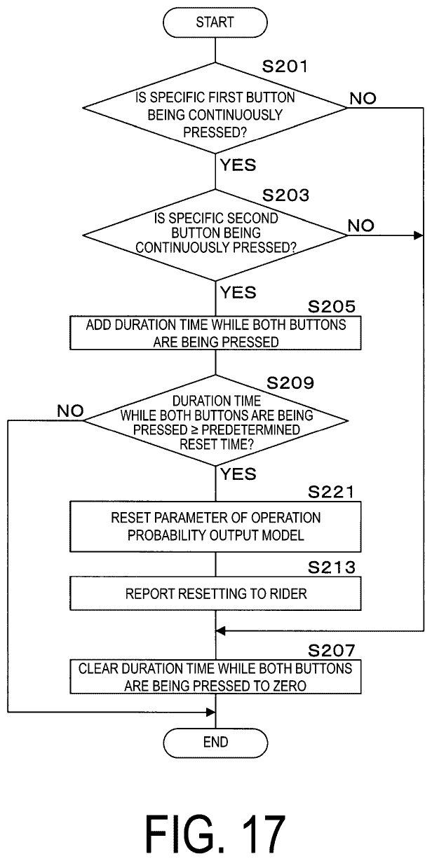

The parameter change unit 116 resets the parameter of the predetermined control algorithm to predetermined data as long as the predetermined condition is satisfied, as illustrated in FIG. 5 of the first embodiment, even in a case where the parameter is changed by using the operation probability output model M1 according to the processing procedure illustrated in FIG. 15 or 16. The parameter change unit 116 in the third embodiment can reset the parameters of the operation probability output model M1 learned for the rider to the predetermined data. FIG. 17 is a flowchart illustrating an example of a reset processing procedure of the control parameter according to the third embodiment. In the processing procedure illustrated in FIG. 17, the same step numbers are assigned to the same procedures as those in the processing procedure illustrated in FIG. 5 of the first embodiment, and detailed description thereof will be omitted.

The reset unit 118 executes the following processing at a predetermined cycle (for example, 100 milliseconds, 1 second, or the like) based on the setting change program P16 together with the setting change by the parameter change unit 116 in parallel with the automatic control by the device control unit 114.

In a case where in step S209, a duration time while both buttons are being pressed is determined to be equal to or longer than a reset time (YES in S209), the reset unit 118 resets the parameters of the operation probability output model M1 to predetermined parameters (step S221). In step S221, the reset unit 118 stores a copy of the parameters of the operation probability output model M1 stored in the memory 112 before shipment of the control device 100 and in an initial state or in a state learned to some extent, and uses the copy as the predetermined parameters.

The reset unit 118 performs a report (S213) after the resetting and clearing (S207) of the duration time while both buttons are being pressed to zero, and ends the processing.

In this manner, the reference cadence is adjusted so as to reliably match the rider's operation intention with respect to the human-powered vehicle 1 according to the situation, the automatic control by the device control unit 114 is more appropriately optimized, and the resetting can be performed in response to a specific operation.

### Fourth Embodiment

In a fourth embodiment, the control device 100 sets a parameter related to automatic control for each section of a travel speed, and performs control so as to balance the parameter with a parameter in another section of the travel speed in changing the parameter related to the automatic control. In the fourth embodiment, a control target of the automatic control is the transmission device 31. The parameter for the gear ratio of the transmission device 31 is changed and optimized based on an intervening operation of a rider, and the parameter is reset.

The configuration of the human-powered vehicle 1 and the configuration of the control device 100 according to the fourth embodiment are similar to the configurations of the human-powered vehicle 1 and the control device 100 according to the first embodiment except for a processing procedure, which will be described below. Therefore, the same components of the human-powered vehicle 1 and the control device 100 according to the fourth embodiment as those of the first embodiment are denoted by the same signs, and detailed description thereof will be omitted.

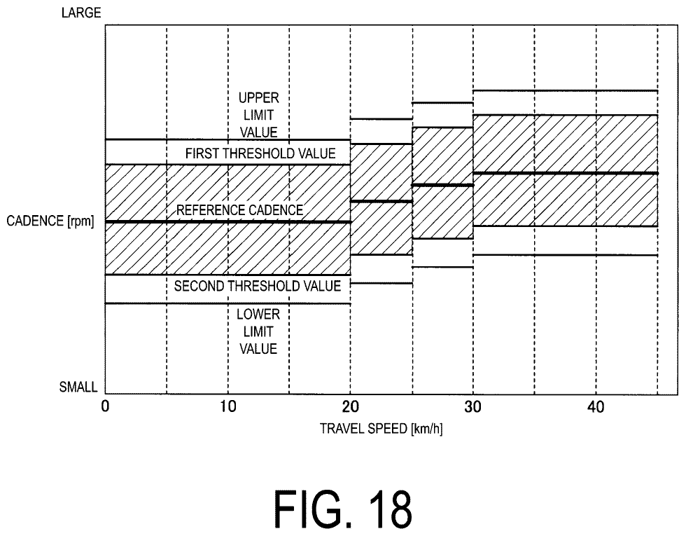

FIG. 18 is a diagram illustrating a setting of a reference cadence in the fourth embodiment. In FIG. 18, the horizontal axis represents a travel speed, and the vertical axis represents magnitude of the reference cadence. In FIG. 18, the reference cadence is indicated by a thick line. For each section of the travel speed, the reference cadence and the upper limit value and lower limit value sandwiching the reference cadence are stored in the memory 112. In the example of FIG. 18, the reference cadence is stored in the memory 112 so as to increase stepwise for each section in a section of the travel speed from 0 (km/h) to 20 (km/h), a section of the travel speed from 20 (km/h) to 25 (km/h), a section of the travel speed from 25 (km/h) to 30 (km/h), and a section of the travel speed equal to or more than 30 (km/h).

In the fourth embodiment, the parameter change unit 116 of the control device 100 changes the reference cadence set for each section of the travel speed illustrated in FIG. 18 such that a difference between reference cadences in adjacent sections is maintained within a predetermined range.

The parameter change unit 116 of the control device 100 according to the fourth embodiment executes processing similar to the processing procedure illustrated in FIG. 4 according to the first embodiment to raise or lower the reference cadence. The parameter change unit 116 of the control device 100 according to the fourth embodiment changes the parameter based on a reference for each section of the travel speed illustrated in FIG. 18 in the processing of step S113 and step S115.

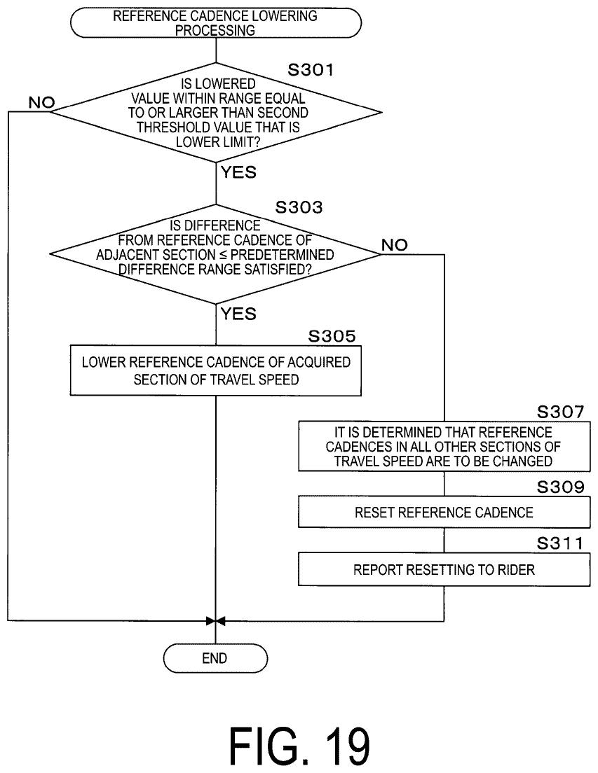

FIG. 19 is a flowchart illustrating an example of a change processing procedure of the reference cadence according to the fourth embodiment. The processing procedure illustrated in FIG. 19 indicates a processing procedure in lowering the reference cadence. The processing procedure illustrated in FIG. 19 corresponds to details of the processing procedure of step S113 in the processing procedure illustrated in FIG. 4.

The parameter change unit 116 determines whether the lowered value of the reference cadence is within a range equal to or more than the second threshold value that is the lower limit in the section of the travel speed included in the input information (step S301). In a case where the lowered value is determined to be within the range equal to or more than the second threshold value (YES in S301), the parameter change unit 116 determines whether a difference between the lowered value and a reference cadence in an adjacent section of the travel speed is within a predetermined difference range (step S303).

In a case where in step S303, the difference between the lowered value and the reference cadence in the adjacent section of the travel speed is determined to be within the predetermined difference range (YES in S303), the parameter change unit 116 lowers the reference cadence in the section of the travel speed included in the input information by a predetermined value (for example, 1 (rpm)) (step S305).

In step S303, in a case where the difference between the lowered value and the reference cadence in the adjacent section of the travel speed is determined to exceed the predetermined difference range (NO in S303), the parameter change unit 116 determines to change reference cadences of all the other sections of the travel speed (step S307). In this case, the parameter change unit 116 resets the reference cadences (step S309). In a case where the resetting is performed, the reset unit 118 reports the resetting by the report unit 40G to the rider (step S311).

In a case where it is determined in step S301 that the lowered value is not within the range equal to or more than the second threshold value (NO in S301), the parameter change unit 116 ends the processing without changing the reference cadence.

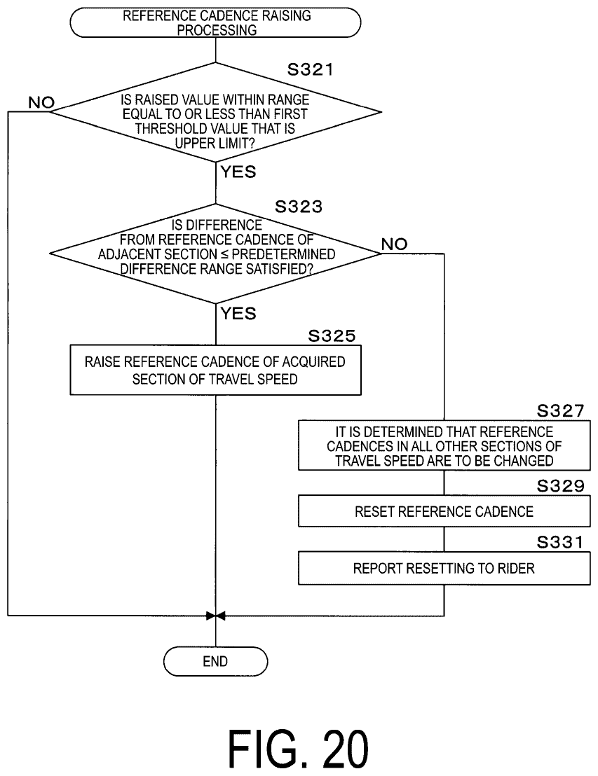

FIG. 20 is a flowchart illustrating an example of a change processing procedure of the reference cadence according to the fourth embodiment. The processing procedure illustrated in FIG. 20 indicates a processing procedure in raising the reference cadence, and the processing procedure illustrated in FIG. 20 corresponds to the details of the processing procedure of step S115 in the processing procedure illustrated in FIG. 4.

The parameter change unit 116 determines whether the raised value of the reference cadence is within a range equal to or less than the first threshold value that is the upper limit in the section of the travel speed included in the input information (step S321). In a case where the raised value is determined to be within the range equal to or less than the first threshold value (YES in S321), the parameter change unit 116 determines whether a difference between the raised value and a reference cadence in an adjacent section of the travel speed is within a predetermined difference range (step S323).

In a case where in step S323, the difference between the raised value and the reference cadence in the adjacent section of the travel speed is determined to be within the predetermined difference range (YES in S323), the parameter change unit 116 raises the reference cadence in the section of the travel speed included in the input information by a predetermined value (for example, 1 (rpm)) (step S325).

In step S323, in a case where the difference between the raised value and the reference cadence in the adjacent section of the travel speed is determined to exceed the predetermined difference range (NO in S323), the parameter change unit 116 determines to change reference cadences of all the other sections of the travel speed (step S327). In this case, the parameter change unit 116 resets the reference cadences (step S329). In a case where the resetting is performed, the reset unit 118 reports the resetting to the rider by the report unit 40G (step S331).

In a case where it is determined in step S321 that the raised value is not within the range equal to or less than the first threshold value (NO in S321), the parameter change unit 116 ends the processing without changing the reference cadence.

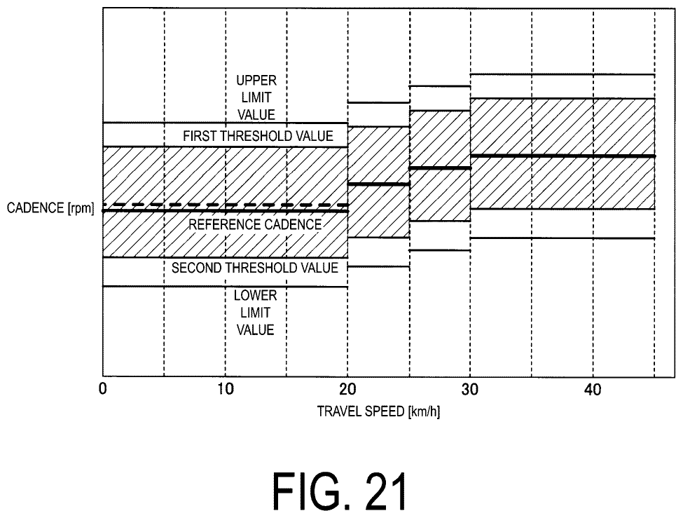

FIG. 21 is a diagram illustrating a setting of the reference cadence after the change. In FIG. 21, similarly to FIG. 18, the horizontal axis represents a travel speed, and the vertical axis represents magnitude of the reference cadence. In FIG. 21, the reference cadence before the change is indicated by a thick dashed line, and the reference cadence after the change is indicated by a thick solid line. In the changed reference cadence illustrated in FIG. 21, the reference cadence in the section of the travel speed from 0 (km/h) to 20 (km/h) is lowered as compared with the reference cadence illustrated in FIG. 18 and is changed such that a difference between the reference cadence in the section of the travel speed from 0 (km/h) to 20 (km/h) and a reference cadence in an adjacent section of the travel speed from 20 (km/h) to 25 (km/h) is maintained.

By setting and changing the reference cadence for each travel section as illustrated in the fourth embodiment, it is possible to perform control so as to reliably match the reference cadence that the rider individually wants to maintain. In a case where the difference between the changed reference cadence and the reference cadence in the adjacent section of the travel speed becomes too large, the reference cadences can be reset to return to the initial reference cadences illustrated in FIG. 18.

### Fifth Embodiment

In a fifth embodiment, a control target of the control device 100 is the transmission device 31. The device control unit 114 compares a torque of the crank 21 output from the torque sensor 63 with a parameter to determine a gear ratio. Automatic control based on a torque of the device control unit 114, which will be described below, can be replaced with the control of the transmission device 31 based on the cadence in the first to fourth embodiments.

A configuration of the control device 100 in the fifth embodiment is similar to that of the control device 100 according to the first embodiment except for the control method by the device control unit 114 and the change target by the parameter change unit 116. In the configuration of the control device 100 according to the fifth embodiment, the same components as those of the first embodiment are denoted by the same signs, and detailed description thereof will be omitted.

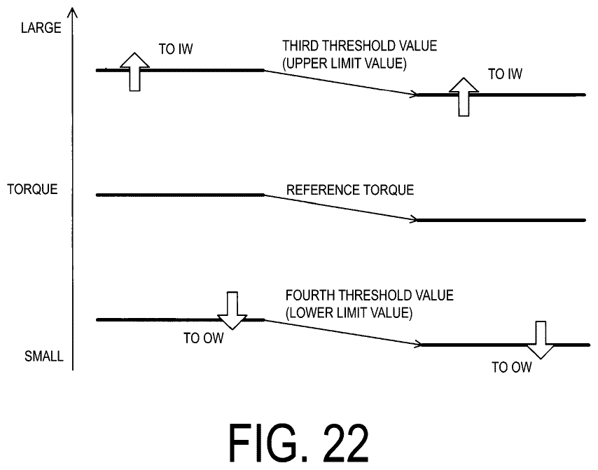

FIG. 22 is a schematic diagram of a control algorithm of the transmission device 31 in the fifth embodiment. FIG. 22 illustrates a reference for changing a gear ratio relative to a torque acquired from the torque sensor 63. The upper side of FIG. 22 indicates a larger torque. The device control unit 114 performs control such that the torque applied to the crank 21 remains at a reference torque. The device control unit 114 performs a procedure for determining a gear ratio by comparing the torque acquired from the torque sensor 63 with a predetermined threshold value. For example, in a case where the torque acquired from the torque sensor 63 reaches or exceeds a third threshold value that is larger than the reference torque, the device control unit 114 determines the gear ratio so as to be made smaller than the current gear ratio. On the other hand, in a case where the torque reaches or falls below a fourth threshold value that is smaller than the reference torque, the device control unit 114 determines the gear ratio so as to be made larger than the current gear ratio.

In the fifth embodiment, the memory 112 of the control device 100 stores the reference cadence, the third threshold value, and the fourth threshold value for determining the gear ratio of the transmission device 31 described above as parameters so as to be changeable. In the fifth embodiment, the processing unit 110 causes the device control unit 114 to raise or lower the reference torque, as the parameter of the automatic control, to be compared with the torque in order to determine the gear ratio in the transmission device 31.

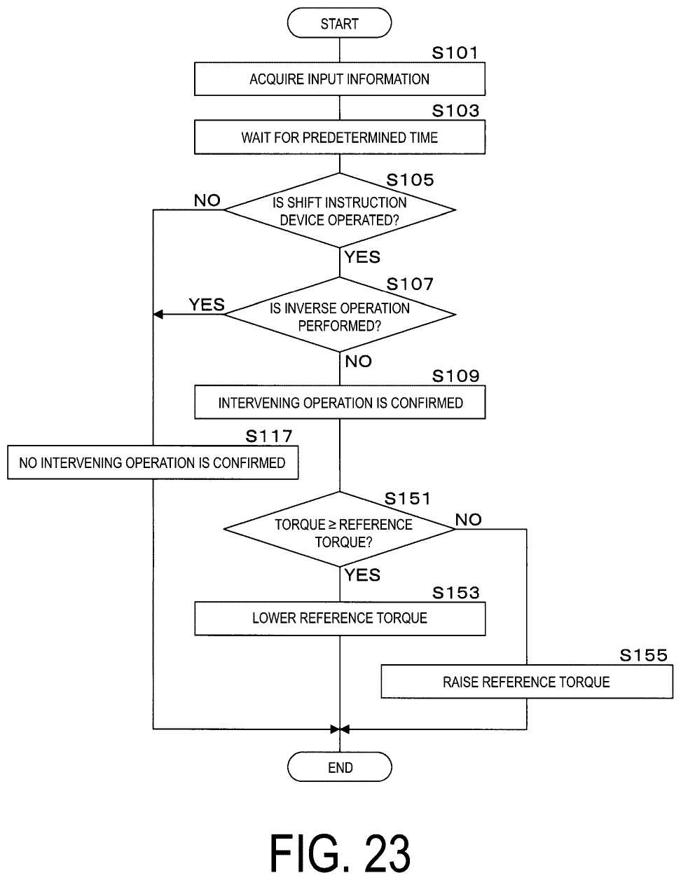

In the fifth embodiment, the parameter change unit 116 changes, as necessary, at least one of the reference torque, the third threshold value, and the fourth threshold value that are used in the control algorithm illustrated in FIG. 22. FIG. 23 is a flowchart illustrating an example of a change processing procedure of the control parameter according to the fifth embodiment. In the processing procedure illustrated in the flowchart in FIG. 23, the same step numbers are assigned to the same procedures as those in the processing procedure illustrated in FIG. 4 of the first embodiment, and detailed description thereof will be omitted.

In a case where the shift instruction device 40B is determined to be operated (YES in S105) and it is determined that the inverse operation has not been performed (NO in S107), the parameter change unit 116 determines that the intervening operation is performed (S109).

The parameter change unit 116 determines whether a torque acquired from the torque sensor 63 is equal to or more than the reference torque (step S151). In a case where the torque is determined to be equal to or more than the reference torque (YES in S151), the parameter change unit 116 lowers the reference torque, which is one of the parameters related to the automatic control (step S153). The processing unit 110 ends the change processing of the parameter related to the automatic control.

In step S153, a rider intends to change the gear ratio in a state where the torque is increasing. Thus, the parameter change unit 116 lowers the reference torque to facilitate control for lowering the gear ratio at the torque (lightening control). Instead of lowering the reference torque, the third threshold value (upper limit) can be lowered.

In a case where in step S151, the torque is determined to be less than the reference torque (NO in S151), the parameter change unit 116 raises the reference torque, which is one of the parameters related to the automatic control (step S155). The processing unit 110 ends the change processing of the parameter related to the automatic control. In step S155, the fourth threshold value (lower limit) can be raised instead of raising the reference torque.

In step S151, the parameter change unit 116 can perform the determination depending on whether the torque is increasing. The parameter change unit 116 can lower the reference torque in a case where the torque is determined to be increasing, and can raise the reference torque in a case where the torque is determined to be decreasing. Instead of changing the reference torque in step S153 or step S155, the parameter change unit 116 can change a timing for changing the gear ratio to be earlier or later.

Also in the fifth embodiment, the control device 100 changes the parameter as illustrated in FIG. 23, but in a case where a predetermined condition is satisfied, the control device 100 resets the learned parameter related to the automatic control to predetermined data. The parameter change unit 116 performs processing similar to the processing procedure illustrated in FIG. 5 according to the first embodiment. In step S211, the reset unit 118 in the fifth embodiment resets the reference torque lowered or raised as described above to the predetermined value stored in the memory 112. The reset unit 118 can also reset the third threshold value and the fourth threshold value to the initial values stored in the memory 112 together with the reference torque.

Through the above-described processing, the reference torque for determining the gear ratio optimized (learned) in the human-powered vehicle 1 for the rider can be reset in a case where a predetermined operation is performed. The rider riding on the human-powered vehicle 1 can reset the parameter in a case where the optimization of the parameter becomes different from the rider's intention. In a case where another rider gets on the human-powered vehicle 1 and starts driving, the parameter related to the automatic control that has been learned so far can be reset.

The control device 100 reports the resetting by the report unit 40G, resulting in causing the rider to recognize that the automatic control is reset.

The control by the device control unit 114 based on the torque described in the fifth embodiment can be applied to the processing using the operation probability output model M1.

### Sixth Embodiment

In a sixth embodiment, a control target of the control device 100 is the assist device 39. The device control unit 114 compares a cadence of the crank 21 output from the cadence sensor 64 with a parameter to determine an output from the assist device 39. Automatic control of the assist device 39 based on the cadence by the device control unit 114, which will be described below, can be replaced with the automatic control of the transmission device 31 based on the cadence in the first to fourth embodiments.

A configuration of the control device 100 in the sixth embodiment is the same as that of the control device 100 according to the first embodiment except for the control method by the device control unit 114 and the change target of the parameter change unit 116. In the configuration of the control device 100 according to the sixth embodiment, the same components as those of the first embodiment are denoted by the same signs, and detailed description thereof will be omitted.

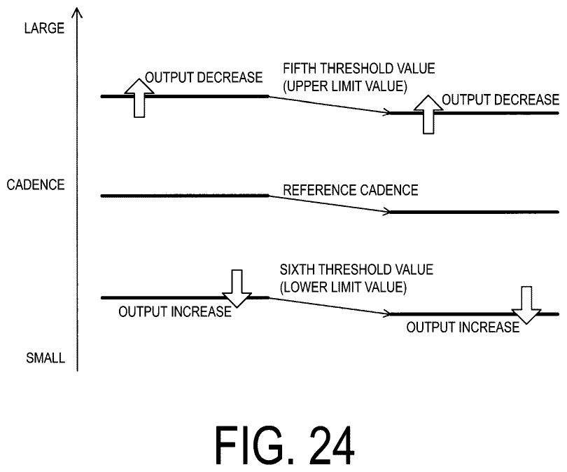

FIG. 24 is a schematic diagram of a control algorithm of the assist device 39 in the sixth embodiment. FIG. 24 illustrates a reference for changing the output of the assist device 39 relative to a cadence acquired from the cadence sensor 64. The upper side of FIG. 24 indicates a larger cadence. The device control unit 114 performs control such that the cadence of the crank 21 remains at the reference cadence. The device control unit 114 performs a procedure for determining the output from the assist device 39 by comparing the cadence acquired from the cadence sensor 64 with a predetermined threshold value. In a case where the cadence acquired from the cadence sensor 64 reaches or exceeds a fifth threshold value (upper limit value), the device control unit 114 determines to lower the output from the assist device 39, that is, to reduce the output. On the other hand, in a case where the cadence reaches or falls below a sixth threshold value (lower limit value), the device control unit 114 determines to raise the output from the assist device 39, that is, to increase the output.

In the sixth embodiment, the processing unit 110, by using the parameter change unit 116, raises or lowers the reference cadence, the reference cadence being to be compared with the cadence for determining the output from the assist device 39.

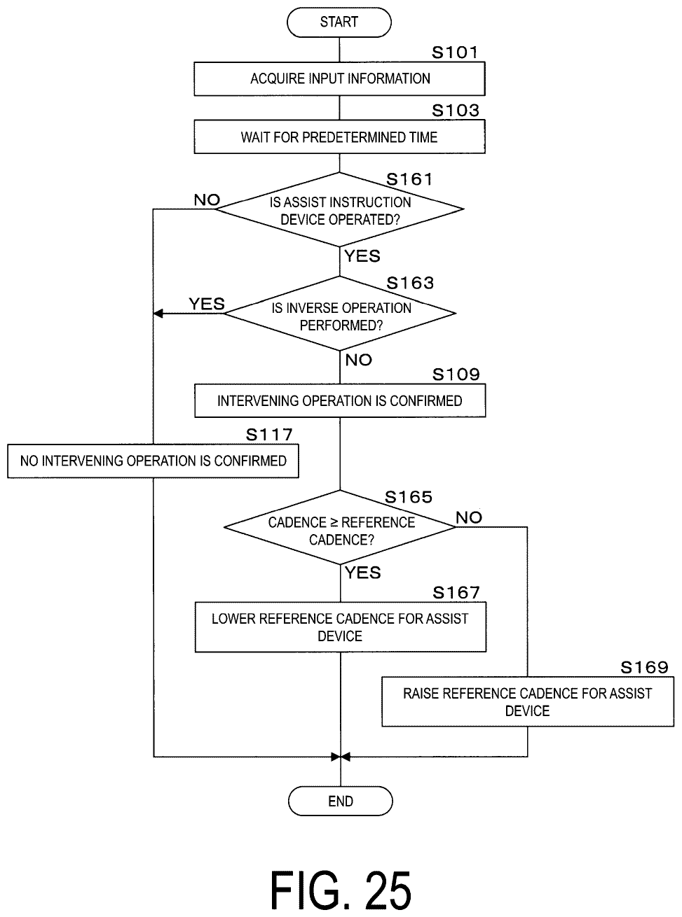

In the sixth embodiment, the parameter change unit 116 changes, as necessary, at least one of the reference cadence, the fifth threshold value, and the sixth threshold value that are used in the control algorithm illustrated in FIG. 24. FIG. 25 is a flowchart illustrating an example of a change processing procedure of a control parameter according to the sixth embodiment. In the processing procedure illustrated in the flowchart in FIG. 25, the same step numbers are assigned to the same procedures as those in the processing procedure illustrated in FIG. 4 of the first embodiment, and detailed description thereof will be omitted.

The parameter change unit 116 acquires input information from the sensor 60 (step S101), waits for a predetermined time (for example, 1 to 3 seconds) (step S103), and determines whether the assist instruction device 40F is operated (step S161).

In a case where the assist instruction device 40F is determined to be operated (YES in S161), the parameter change unit 116 determines whether an inverse operation of the operation in step S161 is performed on the assist instruction device 40F, shortly after the operation in step S161 (for example, within two seconds) (step S163).

In a case where the assist instruction device 40F is determined to be operated (YES in S161) and the inverse operation has not been performed (NO in S163), an intervening operation is confirmed to be performed (S109).

The parameter change unit 116 determines whether the cadence acquired from the cadence sensor 64 is equal to or more than the reference cadence (step S165). In a case where the cadence is determined to be equal to or more than the reference cadence (YES in S165), the parameter change unit 116 lowers the reference cadence, which is one of the parameters related to the automatic control of the assist device 39 (step S167). The processing unit 110 ends the change processing of the parameter related to the automatic control.

In step S167, a rider intends to change the output from the assist device 39 in a state where the cadence is increasing. Thus, the parameter change unit 116 lowers the reference cadence to facilitate control for decreasing (weighing control) the output at the cadence. Instead of lowering the reference cadence, the fifth threshold value (upper limit) can be lowered.

In a case where it is determined in step S161 that the assist instruction device 40F has not been operated (NO in S161), or in step S163, the inverse operation is determined to be performed (YES in S163), it is confirmed that the intervening operation has not been performed (there has been no operation) (step S117), and the parameter change unit 116 ends the processing.

In a case where in step S165, the cadence is determined to be less than the reference cadence (NO in S165), the parameter change unit 116 raises the reference cadence, which is one of the parameters related to the automatic control of the assist device 39 (step S169). The processing unit 110 ends the change processing of the parameter related to the automatic control. In step S169, instead of raising the reference cadence, the sixth threshold value (lower limit) can be raised.

In step S165, the parameter change unit 116 can perform the determination depending on whether the cadence is increasing. The parameter change unit 116 can lower the reference cadence in a case where the cadence is determined to be increasing, and can raise the reference cadence in a case where the cadence is determined to be decreasing. Instead of changing the reference cadence in step S167 or step S169, the parameter change unit 116 can change a timing for changing the output from the assist device 39 to be earlier or later.

Also in the sixth embodiment, the control device 100 changes the parameter as illustrated in FIG. 25, but in a case where a predetermined condition is satisfied, the control device 100 resets the learned parameter related to the automatic control to predetermined data. The parameter change unit 116 performs processing similar to the processing procedure illustrated in FIG. 5 according to the first embodiment. In step S211, the reset unit 118 in the sixth embodiment resets the reference cadence lowered or raised as described above to a predetermined value stored in the memory 112. The reset unit 118 can reset the fifth threshold value and the sixth threshold value to initial values stored in the memory 112 together with the reference cadence.

Through the above-described processing, the reference cadence for determining the output from the assist device 39 optimized (learned) in the human-powered vehicle 1 for the rider can be reset in a case where a predetermined operation is performed. The rider riding on the human-powered vehicle 1 can reset the parameter in a case where the optimization of the parameter becomes different from the rider's intention. In a case where another rider gets on the human-powered vehicle 1 and starts driving, the parameter related to the automatic control that has been learned so far can be reset.

The control device 100 reports the resetting by the report unit 40G, resulting in causing the rider to recognize that the automatic control is reset.

The control by the device control unit 114 based on the cadence described in the sixth embodiment can be applied to the processing using the operation probability output model M1.

### Seventh Embodiment

In a seventh embodiment, the control device 100 sets the reference cadence for each section of a travel speed, and the parameter change unit 116 performs control so as to balance, in changing the parameter related to the automatic control, the parameter with a parameter in another section of the travel speed. In the seventh embodiment, similarly to the sixth embodiment, a control target of the automatic control is the assist device 39. The parameter for the output from the assist device 39 is changed and optimized based on an intervening operation of the rider, and the parameter is reset.

A configuration of the human-powered vehicle 1 and a configuration of the control device 100 according to the seventh embodiment are similar to the configurations of the human-powered vehicle 1 and the control device 100 according to the first embodiment except for a processing procedure, which will be described below. Therefore, the same components of the human-powered vehicle 1 and the control device 100 according to the seventh embodiment as those of the first embodiment are denoted by the same signs, and detailed description thereof will be omitted.

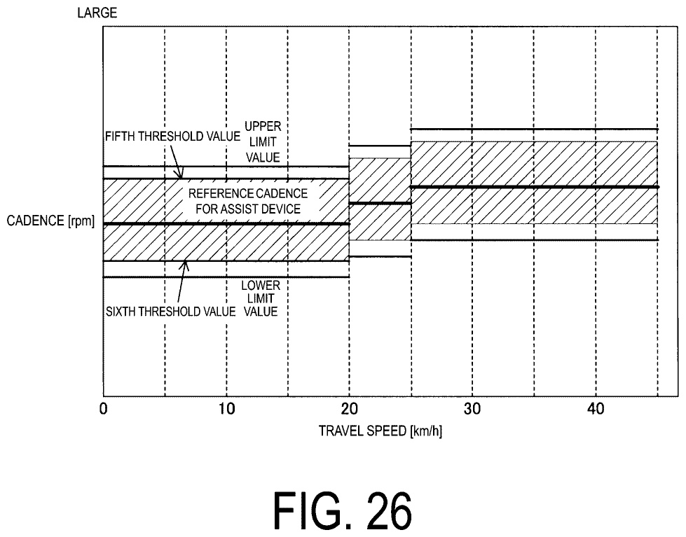

FIG. 26 is a diagram illustrating a setting of the reference cadence in the seventh embodiment. In FIG. 26, the horizontal axis represents a travel speed, and the vertical axis represents magnitude of the reference cadence. In FIG. 26, the reference cadence is indicated by a thick line. For each section of the travel speed, the reference cadence and the upper limit value and lower limit value sandwiching the reference cadence are stored in the memory 112. In the example of FIG. 26, the reference cadence for determining the output from the assist device 39 is stored in the memory 112 so as to increase stepwise for each section in a section of the travel speed from 0 (km/h) to 20 (km/h), a section of the travel speed from 20 (km/h) to 25 (km/h), a section of the travel speed from 25 (km/h) to 30 (km/h), and a section of the travel speed equal to or more than 30 (km/h).

In the seventh embodiment, the parameter change unit 116 of the control device 100 changes the reference cadence for the assist device 39 set for each section of the travel speed illustrated in FIG. 26 such that a difference between reference cadences in adjacent sections is maintained within a predetermined range.

The parameter change unit 116 of the control device 100 according to the seventh embodiment performs processing similar to the processing procedure illustrated in FIG. 25 according to the sixth embodiment. In the processing procedure illustrated in FIG. 25, in the processing of step S163 and step S165, the parameter change unit 116 of the control device 100 according to the seventh embodiment performs lowering the input information acquired in step S101 according to the travel speed.

Also in the seventh embodiment, the parameter change unit 116 executes the processing procedure illustrated in FIG. 19 of the second embodiment in step S167 in FIG. 25, and executes the processing procedure illustrated in FIG. 20 in step S169 in FIG. 25. In the seventh embodiment, one of the reference cadence, a fifth threshold value, and a sixth threshold value for determining the output of the assist device 39 is to be raised and lowered by the parameter change unit 116.

According to the configuration of the seventh embodiment, the reference cadence for determining the output of the assist device 39 is also changed so as to smoothly change for each speed, and the automatic control of the assist device 39 is appropriately optimized. In addition, in a case where it is determined that it is necessary to change the reference cadence in another section adjacent to the section of the travel speed, and the difference from the reference cadence in the adjacent section of the travel speed becomes too large, the reference cadence can be reset to return to an initial reference cadence illustrated in FIG. 26.

### Eighth Embodiment

In an eighth embodiment, a control target of the control device 100 is the assist device 39, The device control unit 114 compares a torque of the crank 21 output from the torque sensor 63 with a parameter to determine an output from the assist device 39.

A configuration of the control device 100 in the eighth embodiment is similar to that of the control device 100 according to the first embodiment except for a control method by the device control unit 114 and a change target of the parameter change unit 116. In the configuration of the control device 100 according to the eight embodiment, the same components as those of the first embodiment are denoted by the same signs, and detailed description thereof will be omitted.

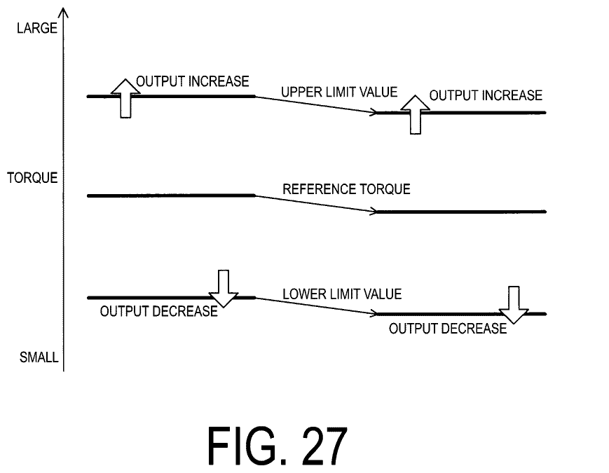

FIG. 27 is a schematic diagram of a control algorithm of the assist device 39 in the eighth embodiment. FIG. 27 indicates a reference for changing the output from the assist device 39 relative to a torque acquired from the torque sensor 63. FIG. 27 indicates magnitude of the torque in a vertical direction, and the torque increases toward an upper side. The device control unit 114 performs control such that the torque applied to the crank 21 remains in the vicinity of the reference torque. The device control unit 114 determines the output from the assist device 39 by comparing the torque acquired from the torque sensor 63 with a seventh threshold value larger than the reference torque and an eighth threshold value smaller than the reference torque. For example, in a case where the torque acquired from the torque sensor 63 reaches or exceeds the seventh threshold value (upper limit) larger than the reference torque, the device control unit 114 determines to raise the output from the assist device 39, that is, to increase the output. Switching to a mode with high output from the assist device 39 can be performed. Switching to a mode with a large ratio of the output from the assist device 39 to a human-powered torque can be performed. On the other hand, in a case where the torque acquired from the torque sensor 63 reaches or falls below the eighth threshold value (lower limit) lower than the reference torque, the device control unit 114 determines to lower the output from the assist device 39, that is, to reduce the output. Switching to a mode with a small output from the assist device 39 can be performed. Switching to a mode with a small ratio of the output from the assist device 39 to the human-powered torque can be performed. The device control unit 114 performs control such that the torque remains in the vicinity of the reference torque even after the output is changed.

In the eighth embodiment, the memory 112 of the control device 100 stores the reference torque, the seventh threshold value, and the eighth threshold value for the output of the assist device 39 described above as parameters so as to be changeable. The processing unit 110 of the control device 100, as the parameter change unit 116, performs processing of changing the reference torque by either raising or lowering the reference torque, the reference torque being to be compared with the torque for determining the output of the assist device 39 described above.

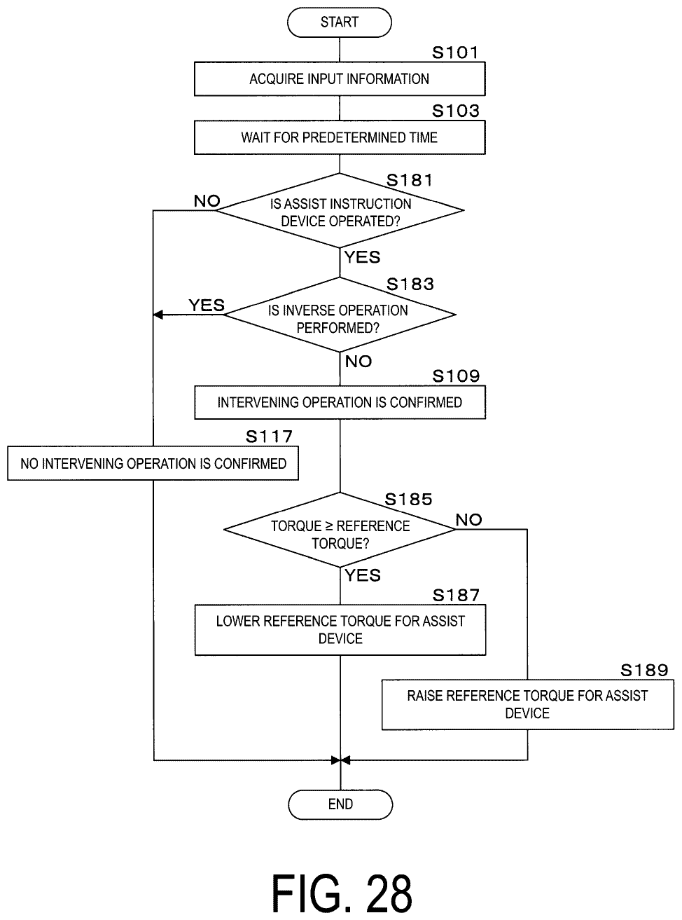

FIG. 28 is a flowchart illustrating an example of a change procedure of a control parameter according to the eighth embodiment. In the processing procedure illustrated in the flowchart in FIG. 28, the same step numbers are assigned to the same procedures as those in the processing procedure illustrated in FIG. 4 of the first embodiment, and detailed description thereof will be omitted.

The parameter change unit 116 acquires input information from the sensor 60 (S101), waits for a predetermined time (for example, 1 to 3 seconds) (step S103), and determines whether the assist instruction device 40F is operated (step S181).

In a case where the assist instruction device 40F is determined to be operated (YES in S181), the parameter change unit 116 determines whether an inverse operation of the operation in step S181 is performed on the assist instruction device 40F, shortly after the operation in step S181 (for example, within two seconds) (step S183).

In a case where the assist instruction device 40F is determined to be operated (YES in S181) and the inverse operation has not been performed (NO in S183), it is confirmed that an intervening operation is performed (S109).

The parameter change unit 116 determines whether a torque acquired from the torque sensor 63 is equal to or more than the reference torque related to the output of the assist device 39 (step S185). In a case where the torque is determined to be equal to or more than the reference torque (YES in S185), the parameter change unit 116 lowers the reference torque, which is one of the parameters related to the automatic control of the assist device 39 (step S187). The processing unit 110 ends the change processing of the parameter related to the automatic control.

In step S183, a rider intends to change the output from the assist device 39 in a state where the torque is increasing. Thus, the parameter change unit 116 lowers the reference torque to facilitate control for increasing (lightening control) the output at the torque. Instead of lowering the reference torque, the seventh threshold value (upper limit) can be lowered.

In a case where in step S185, the torque is determined to be less than the reference torque (NO in S185), the parameter change unit 116 raises the reference torque, which is one of the parameters related to the automatic control of the assist device 39 (step S189). The processing unit 110 ends the change processing of the parameter related to the automatic control. In step S189, the rider intends to change the output from the assist device 39 in a state where the torque is decreasing. Thus, the reference torque is raised to facilitate control for decreasing (weighing control) the output at the torque. Instead of raising the reference torque, the eighth threshold value (lower limit) can be raised.

In a case where it is determined in step S181 that the assist instruction device 40F has not been operated (NO in S181), or in step S183, an inverse operation is determined to be performed (YES in S183), it is confirmed that an intervening operation has not been performed (there has been no operation) (S117), and the parameter change unit 116 ends the processing.

In step S185, the parameter change unit 116 can perform the determination depending on whether the torque is increasing. The parameter change unit 116 can lower the reference torque in a case where the torque is determined to be increasing, and can raise the reference torque in a case where the torque is determined to be decreasing. Instead of changing the reference torque in step S187 or step S189, the parameter change unit 116 can change a timing for changing the output of the assist device 39 to be earlier or later.

Through the above-described processing, the reference torque for determining the output from the assist device 39 optimized (learned) in the human-powered vehicle 1 for the rider can be reset in a case where a predetermined operation is performed. The rider riding on the human-powered vehicle 1 can reset the parameter in a case where the optimization of the parameter becomes different from the rider's intention. In a case where another rider gets on the human-powered vehicle 1 and starts driving, the parameter related to the automatic control that has been learned so far can be reset.

The control by the device control unit 114 based on the torque described in the eighth embodiment can be applied to the processing using the operation probability output model M1.

### Ninth Embodiment

The automatic control by the device control unit 114 is not limited to the transmission device 31 or the assist device 39, and a reference to be referred to automatically control each of the controlled devices 30 is not limited to the cadence, the torque, and the travel speed. The control device 100 can have a control target including each of the suspension 33, the seat post 35, and the braking device 37.

The control device 100 according to the ninth embodiment can perform automatic control (FIG. 4) in which the control target is the suspension 33. In a case where the control target is the suspension 33 and the automatic control is ON, the control device 100 compares at least one of an inclination of the human-powered vehicle 1 acquired from the gyro sensor 65, vibrations acquired from the acceleration sensor 62, and a road surface condition based on analysis of an image acquired from the camera 67 with a parameter defined in the setting data to determine a coefficient of restitution of the suspension 33, and controls the suspension 33. The processing unit 110 of the control device 100 changes a threshold value (parameter) defining a range of the inclination in a case where an intervening operation is performed according to the change processing of the parameter. For example, in a case where the inclination of the human-powered vehicle 1 in a roll direction during traveling is increasing (at the start of going up or going down a slope), and even in a case where the inclination during traveling does not reach an upper limit value of the inclination range, the processing unit 110 changes and lowers the upper limit value (parameter) of a target range in a case where the intervening operation of lowering and softening the coefficient of restitution of the suspension 33 is performed on the suspension instruction device 40C. In contrast, in a case where the inclination of the human-powered vehicle 1 in the roll direction during traveling is decreasing (at the end of going up or going down of the slope), and even in a case where the inclination during traveling does not reach a lower limit value of the inclination range, the processing unit 110 changes and raises the lower limit value (parameter) of the target range in a case where the intervening operation of raising and hardening the coefficient of restitution of the suspension 33 is performed on the suspension instruction device 40C. The control device 100 also resets the parameter related to the suspension 33 to predetermined data in a case where a predetermined condition is satisfied.

In another example, the processing unit 110 of the control device 100 changes a threshold value defining a power range of vibrations in a case where an intervening operation is performed, according to a change processing of a parameter related to the automatic control. For example, based on data acquired from the acceleration sensor 62, even in a case where the power of the vibrations does not reach an upper limit value of the power range while the vibrations of the human-powered vehicle 1 during traveling are increasing, the processing unit 110 changes and lowers the upper limit value (parameter) of the target range in a case where an intervening operation of lowering and softening a coefficient of restitution of the suspension 33 is performed on the suspension instruction device 40C. Conversely, even in a case where the power of the vibrations does not reach a lower limit value of the power range while the vibrations of the human-powered vehicle 1 during traveling are decreasing, the processing unit 110 changes and raises the lower limit value (parameter) of the target range in a case where an intervening operation of raising and hardening the coefficient of restitution of the suspension 33 is performed on the suspension instruction device 40C.

In another example, the processing unit 110 of the control device 100 changes a threshold value defining a determination range of a road surface condition in a case where an intervening operation is performed, according to a change processing of a parameter related to the automatic control. For example, even in a case where, based on an image acquired from the camera 67, the road surface condition is not within a range of conditions determined to be off-road while the road surface condition of the human-powered vehicle 1 during traveling is changing from an on-road state toward an off-road state, the processing unit 110 changes a parameter for the image so that the road surface condition is easily determined to be off-road from the image in a case where an intervening operation is performed on the suspension instruction device 40C, the intervening operation being for lowering and softening the coefficient of restitution of the suspension 33. On the other hand, in the processing unit 110, even in a case where the road surface condition is not within a range of conditions determined to be on-road while the road surface condition of the human-powered vehicle 1 during traveling is changing from the off-road state to the on-road state, the processing unit 110 changes the parameter for the image so that the road surface condition is easily determined to be on-road from the image in a case where an intervening operation is performed on the suspension instruction device 40C, the intervening operation being for raising and hardening the coefficient of restitution of the suspension 33.

In a case where the control target is the braking device 37 and the automatic control is ON, the control device 100, by comparing at least one of a speed acquired from the speed sensor 61, an acceleration and vibrations acquired from the acceleration sensor 62, and a traveling condition acquired from the camera 67 or a radar with a parameter related to the control, determines one of a braking start and a braking end of the braking device 37, and controls the braking device 37. The processing unit 110 of the control device 100 changes threshold values (parameters) defining ranges of the speed and the acceleration at which braking is to be performed in a case where an intervening operation is performed, according to the change processing of the setting data illustrated in the flowchart of FIG. 4. For example, even in a case where the acceleration does not reach an upper limit value of the range of the acceleration while the acceleration during the traveling is increasing, the processing unit 110 changes and lowers the upper limit value of the target range in a case where an intervening operation for starting the braking is performed on the braking instruction device 40E. On the other hand, even in a case where the acceleration does not reach a lower limit value of the range of the acceleration while the acceleration during the traveling is decreasing, the processing unit 110 changes and raises the lower limit value (parameter) of the target range in a case where an intervening operation for ending the braking is performed on the braking instruction device 40E.

In another example, the processing unit 110 of the control device 100 changes a threshold value defining a traveling condition in which braking is started in a case where an intervening operation is performed, according to the change processing of a parameter related to the automatic control. For example, even in a case where the traveling condition acquired from the camera 67 or a radar during traveling is not a state in which a distance to a person or an object in front is equal to or less than a set distance for starting the braking, the processing unit 110 changes and increases the set distance (parameter) in a case where the intervening operation for starting the braking is performed on the braking instruction device 40E. Even in a case where a speed is not equal to or less than a predetermined speed in the situation in which the distance to the person or the object in front is equal to or less than the set distance, the processing unit 110 changes and increases the predetermined speed (parameter) in a case where the intervening operation for ending the braking is performed on the braking instruction device 40E.

In another example, the processing unit 110 of the control device 100 changes a threshold value defining a range of vibrations in which braking is started in a case where an intervening operation is performed, according to the change processing of a parameter related to the automatic control. For example, even in a case where vibrations corresponding to a traveling condition acquired from the acceleration sensor 62 (vibrations for determining whether the vehicle is traveling on a bad road) does not reach an upper limit value of a vibration range, the processing unit 110 changes and lowers the upper limit value (parameter) of the vibration range in a case where the intervening operation for starting the braking is performed on the braking instruction device 40E. In a case where a predetermined condition is satisfied, the control device 100 also resets the parameter related to the braking device 37 to predetermined data.

In a case where a control target is the seat post 35 and the automatic control is ON, the control device 100 determines a height of the seat post 35 by comparing at least one of an inclination of the human-powered vehicle 1 acquired from the gyro sensor 65, vibrations acquired from the acceleration sensor 62, and a road surface condition based on analysis of an image acquired from the camera 67 with a parameter set in the setting data to control the seat post 35. The processing unit 110 of the control device 100 changes a threshold value defining an inclination range within which the seat post 35 is to be moved in a case where an intervening operation is performed, according to the change processing of a parameter related to the automatic control. For example, in a situation in which it can be determined that an inclination of the human-powered vehicle 1 in the roll direction during traveling is an inclination of the human-powered vehicle 1 going up a slope, even in a case where the inclination does not reach an upper limit value of the inclination range, the processing unit 110 changes and lowers the upper limit value of the target range in a case where an intervening operation of lowering the seat post 35 is performed on the seat post instruction device 40D. Conversely, in a situation in which it can be determined that the inclination of the human-powered vehicle 1 in the roll direction during traveling is an inclination of the human-powered vehicle 1 having started traveling on a flat road, even in a case where the inclination during traveling has not reached a lower limit value of the inclination range, the processing unit 110 changes and raises the lower limit value of the target range in a case where an intervening operation of raising the seat post 35 is performed on the seat post instruction device 40D.

In another example, the processing unit 110 of the control device 100 changes a threshold value of a vibration range within which the seat post 35 is to be moved in a case where an intervening operation is performed, according to the change processing of a parameter related to the automatic control. For example, even in a case where vibrations of the human-powered vehicle 1 during traveling do not reach or exceed a first threshold value based on which the human-powered vehicle 1 can be determined to have reached a bad road, the processing unit 110 updates and lowers the first threshold value in a case where an intervening operation of lowering the seat post 35 is performed on the seat post instruction device 40D. Even in a case where the vibrations of the human-powered vehicle 1 during traveling do not reach a value less than a second threshold value based on which the human-powered vehicle 1 can be determined to have departed from the bad road, the processing unit 110 changes and raises the second threshold value in a case where an intervening operation of raising the seat post 35 is performed on the seat post instruction device 40D.

In another example, the processing unit 110 of the control device 100 changes setting data defining a traveling condition based on which the seat post 35 is to be moved in a case where an intervening operation is performed, according to the change processing of a parameter related to the automatic control. For example, even in a case where a traveling condition acquired from the camera 67 during traveling has not been in a situation in which the traveling condition is determined to be off-road and uphill, the processing unit 110 changes a parameter for an image such that the traveling condition is determined to be off-road and uphill in a case where an intervening operation of lowering the seat post 35 is performed on the seat post instruction device 40D. Similarly, even in a case where the traveling condition acquired from the camera 67 during traveling has not been in a situation in which the traveling condition is determined to be on-road and flat, the processing unit 110 changes the parameter for the image such that the traveling condition is determined to be on-road and flat in a case where an intervening operation of raising the seat post 35 is performed on the seat post instruction device 40D. In a case where a predetermined condition is satisfied, the control device 100 also resets the parameter related to the seat post 35 to predetermined data.

Thus, the parameters related to the suspension 33, the seat post 35, and the braking device 37 optimized (learned) in the human-powered vehicle 1 for a rider are optimized as appropriate. Further, the parameter can be reset in a case where a predetermined operation is performed. The rider riding on the human-powered vehicle 1 can reset the parameter in a case where the optimization of the parameter becomes different from the rider's intention. In a case where another rider gets on the human-powered vehicle 1 and starts driving, the parameter related to the automatic control that has been learned so far can be reset.

As described above, the disclosed embodiments are illustrative in all respects, and are not restrictive. The scope of the present invention is defined by the appended claims, and all changes that come within the meaning and range of equivalency of the claims are intended to be embraced therein.

The phrase “at least one” as used in this specification means “one or more” of desired options. As one example, in a case where the number of options is two, the phrase “at least one” as used in this description means “only one option” or “both of the two options”. As another example, in a case where the number of options is three or more, the phrase “at least one” as used in this description means “only one option” or “any combination of two or more options”. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

### REFERENCE SIGNS LIST

1 Human-powered vehicle, 10 Vehicle body, 10A Frame, 10B Front fork, 12 Handlebar, 14 Front wheel, 16 Rear wheel, 18 Saddle, 20 Driving mechanism, 21 Crank, 21A Crankshaft, 21B Right crank, 21C Left crank, 23 First sprocket assembly, 23A Sprocket, 25 Second sprocket assembly, 25A Sprocket, 27 Chain, 29 Pedal, 30 Device, 31 Transmission device, 33 Suspension, 35 Seat post, 351 Saddle, 37 Braking device, 371 Front brake device, 372 Rear brake device, 39 Assist device, 40 Operation apparatus, 40A Operation device, 40B Shift instruction device, 40C Suspension instruction device, 40D Seat post instruction device, 40E Braking instruction device, 40F Assist instruction device, 40G Report unit, 40H Display unit, 50 Battery, 51 Battery body, 53 Battery holder, 60 Sensor, 61 Speed sensor, 62 Acceleration sensor, 63 Torque sensor, 64 Cadence sensor, 65 Gyro sensor, 66 Seating sensor, 67 Camera, 68 Position information sensor, 300 Human-powered vehicle control system, 7 Information terminal device, 70 Processing unit, 72 Memory, 74 Display unit, 76 Operation device, 78 Communication unit, P7 Application program, 8 Server device, 80 Processing unit, 82 Memory, 84 Communication unit, 100 Control device, 110 Processing unit, 112 Memory, 114 Device control unit, 116 Parameter change unit, 118 Reset unit, 120 Wireless communication device, P14 Device control program, P16 Setting change program, 200 Non-transitory storage medium, P2 Application program, 900 Non-transitory storage medium, P94 Device control program, P96 Setting change program

What is claimed is:

1. A human-powered vehicle control device comprising:
a processor configured to read information from a memory and execute processing,
the processor being further configured to execute processing of:
acquiring input information related to traveling of a human-powered vehicle;
performing automatic control on a controlled device provided to the human-powered vehicle by control data of the controlled device, the control data being decided based on the input information acquired;
changing, based on the input information, a parameter related to automatic control of the controlled device through learning an intervening operation performed on the automatic control by a rider; and
resetting the parameter related to the automatic control, which is changed through learning, to predetermined data in a case where a predetermined condition is satisfied.

2. The human-powered vehicle control device according to claim 1, wherein
the processor is further configured to execute processing of:
deciding the control data in accordance with a predetermined control algorithm based on the input information; and
resetting a parameter of the predetermined control algorithm as the parameter related to the automatic control to the predetermined data in a case where the predetermined condition is satisfied.

3. The human-powered vehicle control device according to claim 1, wherein
the processor is further configured to execute processing of:
deciding the control data in accordance with a predetermined control algorithm based on the input information;
changing the parameter of the predetermined control algorithm in a case where a probability of a rider performing the intervening operation on the automatic control of the controlled device is determined to be equal to or more than a predetermined value using an operation probability output model that outputs a probability of a rider performing an intervening operation on the automatic control of the controlled device; and
resetting at least one of parameters of the operation probability output model and the parameter of the predetermined control algorithm to the predetermined data in a case where the predetermined condition is satisfied.

4. The human-powered vehicle control device according to claim 3, wherein
the processor is further configured to change the parameter of the predetermined control algorithm in a case where the probability output from the operation probability output model is equal to or more than the predetermined value, and the intervening operation having been performed is confirmed.

5. The human-powered vehicle control device according to claim 1, wherein
the processor is further configured to use a specific operation performed to an operation device of the human-powered vehicle as the predetermined condition and reset the parameter in a case where the specific operation is performed.

6. The human-powered vehicle control device according to claim 1, wherein
the input information includes a travel speed of the human-powered vehicle,
the parameter is set for each different section of the travel speed, and
the processor is further configured to execute resetting in a case where, under the predetermined condition in which not only a parameter of a section including the travel speed of the input information but also a parameter of another section is changed, it is determined that the parameter of another section is changed.

7. The human-powered vehicle control device according to claim 1, wherein
the processor is further configured to report resetting to a rider in a case where the processor executes a reset.

8. The human-powered vehicle control device according to claim 7, wherein
the resetting is reported to the rider by at least one of text, color or brightness displayed on a display unit.

9. The human-powered vehicle control device according to claim 8, wherein
the display unit is a display configured to be disposed at a handlebar of the human-powered vehicle.

10. The human-powered vehicle control device according to claim 8, wherein
the display unit is a part of an information terminal device of a rider of the human-powered vehicle.

11. The human-powered vehicle control device according to claim 1, wherein
the controlled device is a transmission device of the human-powered vehicle, and the input information includes a cadence of a crank in a driving mechanism of the human-powered vehicle, and
the processor is further configured to raise or lower a reference cadence as the parameter, the reference cadence being compared to the cadence for determining a gear ratio in the transmission device.

12. The human-powered vehicle control device according to claim 11, wherein
the input information includes a travel speed of the human-powered vehicle,
the reference cadence is set for each different section of the travel speed, and
the processor is further configured to change the reference cadence in a section including the travel speed of the input information while maintaining a difference from a reference cadence in an adjacent section within a predetermined range.

13. The human-powered vehicle control device according to claim 1, wherein
the controlled device is a transmission device of the human-powered vehicle, and the input information includes a torque of a crank in a driving mechanism of the human-powered vehicle, and
the processor is further configured to raise or lower a reference torque as the parameter, the reference torque being compared to the torque for determining a gear ratio in the transmission device.

14. The human-powered vehicle control device according to claim 1, wherein
the controlled device is an assist device of the human-powered vehicle, and the input information includes a cadence of a crank in a driving mechanism of the human-powered vehicle, and
the processor is further configured to raise or lower a reference cadence as the parameter, the reference cadence being compared to the cadence for determining an output of the assist device.

15. The human-powered vehicle control device according to claim 14, wherein
the input information includes a travel speed of the human-powered vehicle,
the reference cadence is set for each different section of the travel speed, and
the processor is further configured to change the reference cadence in a section including the travel speed of the input information while maintaining a difference from a reference cadence in an adjacent section within a predetermined range.

16. The human-powered vehicle control device according to claim 1, wherein
the controlled device is an assist device of the human-powered vehicle, and the input information includes a torque of a crank in a driving mechanism of the human-powered vehicle, and
the processor is further configured to raise or lower a reference torque as the parameter, the reference torque being compared to the torque included for determining an output of the assist device.

17. A human-powered vehicle control method executed by a computer, the human-powered vehicle control method comprising:
acquiring input information related to traveling of a human-powered vehicle;
deciding control data of a controlled device provided to the human-powered vehicle based on the input information acquired;
changing, based on the input information, a parameter related to automatic control of the controlled device through learning an intervening operation performed on the automatic control by a rider; and
resetting the parameter related to the automatic control, which is changed through learning, to predetermined data in a case where a predetermined condition is satisfied.

18. A computer program disposed upon a non-transitory computer readable storage medium and executable by a computer, the computer program being configured to cause the computer to execute processing of:
acquiring input information related to traveling of a human-powered vehicle;
deciding control data of a controlled device provided to the human-powered vehicle based on the input information acquired;
changing, based on the input information, a parameter related to automatic control of the controlled device through learning an intervening operation performed on the automatic control by a rider; and
resetting the parameter related to the automatic control, which is changed through learning, to predetermined data in a case where a predetermined condition is satisfied.
